(19) United States
(12) Patent Application Publication
(10) Pub. No.: US 2015/0046259 A1
(43) Pub. Date: Feb. 12, 2015

(54) SYSTEMS AND METHODS FOR PERSONALIZED ORCHESTRATION OF BUSINESS INFORMATION

(71) Applicant: YP Intellectual Property LLC, Tucker, GA (US)

(72) Inventors: Wendell Hicken, La Verne, CA (US); Sanjay Sood, Claremont, CA (US); Grace Mase, Glendale, CA (US); Mark Shuman, La Canada, CA (US)

(73) Assignee: YP Intellectual Property LLC, Tucker, GA (US)

(21) Appl. No.: 14/079,581

(22) Filed: Nov. 13, 2013

Related U.S. Application Data
(60) Provisional application No. 61/864,320, filed on Aug. 9, 2013.

(51) Int. Cl. G06Q 30/02

(52) U.S. Cl. CPC G06Q 30/0256
USPC 705/14.54

(57) ABSTRACT

Systems and methods for personalized orchestration of business information are provided. Responsive to a request, personalized curation information for an identified end user may be accessed and may include geo-relevant graph information, collection information specifying collection characteristics corresponding to collections associated with the identified end user, and/or window information specifying window characteristics corresponding to business participants in a listing directory service and having been previously associated with the identified end user consequent to indications of end-user interest. A set of business information related to the one or more business participants may be accessed, may include business listing information, and may be windowed as a function of the window information. The windowing may include processing the set of business information based on the personalized curation information to form a windowed set of information, and may further include transmitting the windowed set to facilitate display of the personalized business information.

### BACKGROUND

Certain embodiments of the present disclosure relate generally to managing business information, and in particular to systems and methods for personalized orchestration of business information.

As value, use, access, and demand corresponding to information continue to increase, consumers demand more of the products and services they use than ever before. Businesses are expected to compete to provide greater and greater levels of service and more tailored service offerings. However, searching for, obtaining, managing, and sharing information about businesses can be inconvenient and disorderly. There is a need for features and functionality to streamline business information searching, obtaining, managing, and sharing, and to provide greater availability and quality of tailored service offerings to consumers.

### BRIEF SUMMARY

Certain embodiments of the present disclosure relate generally to managing business information, and in particular to systems and methods for personalized orchestration of business information.

In one aspect, a computer-implemented method for personalized orchestration of business information relating to one or more businesses of interest to an identified end user is provided. A request for personalized business information related to one or more businesses may be processed. The request may be received via a network and may correspond to an identified user. Responsive to the request for personalized business information, personalized curation information for the identified end user may be accessed. The personalized curation information for the identified end user may be retained in at least one repository of one or more repositories. The personalized curation information for the identified end user may be based at least in part on information related to the identified end user that came electronically from an end-user computing device. The personalized curation information for the identified end user may include geo-relevant graph information, including one or more of: collection information at least partially specifying one or more collection characteristics corresponding to one or more collections associated with the identified end user, wherein each collection of the one or more collections is associated with a respective theme; and/or window information at least partially specifying one or more window characteristics corresponding to one or more business participants in a listing directory service, the one or more business participants having been previously associated with the identified end user consequent to processing one or more indications of end-user interest. A set of business information related to the one or more business participants in the listing directory service may be accessed. The set of business information may include business listing information and may be retained in at least one repository of the one or more repositories. The set of business information related to the one or more business participants may be windowed. The windowing may be at least partially a function of the window information. The windowing may include processing the set of business information related to the one or more business participants based at least in part on the personalized curation information for the identified end user to at least partially form a windowed set of information. The windowing may include transmitting, via the network, the windowed set of business information to facilitate display of at least part of the personalized business information.

In another aspect, a system to provide personalized orchestration of business information relating to one or more businesses of interest to an identified end user is provided. One or more network interfaces may be configured to facilitate access to one or more networks. One or more processors may be coupled to the one or more network interfaces. One or more storage media may be coupled to the processor to retain instructions, the one or more processors to execute the instructions to perform one or more of the following. A request for personalized business information related to one or more businesses may be processed, the request being received via at least one of the one or more networks and corresponding to an identified user. Responsive to the request for personalized business information, personalized curation information for the identified end user may be accessed. The personalized curation information for the identified end user may be retained in at least one repository of one or more repositories. The personalized curation information for the identified end user may be based at least in part on information related to the identified end user that came electronically from an end-user computing device. The personalized curation information for the identified end user may include geo-relevant graph information, including one or more of: collection information at least partially specifying one or more collection characteristics corresponding to one or more collections associated with the identified end user, wherein each collection of the one or more collections is associated with a respective theme; and/or window information at least partially specifying one or more window characteristics corresponding to one or more business participants in a listing directory service, the one or more business participants having been previously associated with the identified end user consequent to processing one or more indications of end-user interest. A set of business information related to the one or more business participants in the listing directory service may be accessed. The set of business information may include business listing information and may be retained in at least one repository of the one or more repositories. The set of business information may be related to the one or more business participants. The windowing may be at least partially a function of the window information. The windowing may include processing the set of business information related to the one or more business participants based at least in part on the personalized curation information for the identified end user to at least partially form a windowed set of information. The windowing may include transmitting, via at least one of the one or more networks, the windowed set of business information to facilitate display of at least part of the personalized business information.

In yet another aspect, one or more non-transitory machine-readable media having machine-readable instructions thereon is provided. The instructions, when executed by one or more computers or other processing devices, implement a method for personalized orchestration of business information relating to one or more businesses of interest to an identified end user, causing the one or more computers or other processing devices to perform one or more of the following. A request for personalized business information related to one or more businesses may be processed, the request being received via a network and corresponding to an identified user. Responsive to the request for personalized business information, personalized curation information for the identified end user may be accessed. The personalized curation information for the identified end user may be retained in at least one repository of one or more repositories. The personalized curation information for the identified end user may be based at least in part on information related to the identified end user that came electronically from an end-user computing device. The personalized curation information for the identified end user may include geo-relevant graph information, including one or more of: collection information at least partially specifying one or more collection characteristics corresponding to one or more collections associated with the identified end user, wherein each collection of the one or more collections is associated with a respective theme; and/or window information at least partially specifying one or more window characteristics corresponding to one or more business participants in a listing directory service, the one or more business participants having been previously associated with the identified end user consequent to processing one or more indications of end-user interest. A set of business information related to the one or more business participants in the listing directory service accessed. The set of business information may include business listing information and may be retained in at least one repository of the one or more repositories. The set of business information related to the one or more business participants may be windowed. The windowing may be at least partially a function of the window information. The windowing may include processing the set of business information related to the one or more business participants based at least in part on the personalized curation information for the identified end user to at least partially form a windowed set of information. The windowing may include transmitting, via the network, the windowed set of business information to facilitate display of at least part of the personalized business information.

In some embodiments, the request for personalized may correspond to a request to facilitate information display in accordance with the personalized curation information for the identified end user. The transmitting the windowed set of business information may be directed to the end-user computing device or another end-user computing device associated with the end user.

In some embodiments, the request for personalized business information may correspond to a share request. The transmitting the windowed set of business information may be directed to a second end-user computing device that is associated with a second end user that is different from the identified end user.

In some embodiments, the windowing the set of business information related to the one or more business participants may include checking the set of business information related to the one or more business participants for updated information. The windowing the set of business information related to the one or more business participants may include, consequent to identifying updated information pertaining to at least one of the one or more business participants, including the updated information pertaining to at least one of the one or more business participants in the windowed set of information.

In some embodiments, the window information may include geo-specific criteria, and the windowed set of information may include geo-specific business information identified based at least in part on the geo-specific criteria.

In some embodiments, an indication of end-user interest in a first business may be processed, and the first business may be correlated to a relevant collection of the one or more collections, based at least in part on identifying a relevance of the first business to a theme of the relevant collection.

In some embodiments, the windowed set of information may include user-generated content garnered from one or more of: the end user; the listing service; and/or a third part data source.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a high-level block diagram of a system, in accordance with certain embodiments of the present disclosure.

FIGS. 2A and 2B are high-level block diagrams of one example of a business information handling system, in accordance with certain embodiments of the present disclosure.

FIG. 3 is a block diagram of a mobile computing device, in accordance with certain embodiments of the present disclosure.

FIG. 4 is a block diagram that illustrates an example method of certain aspects of a personalized business information orchestration, in accordance with certain embodiments of the present disclosure.

FIG. 5 is a block diagram that illustrates an example method of certain aspects of a personalized business information orchestration, in accordance with certain embodiments of the present disclosure.

FIG. 6 is a block diagram that illustrates an example method of certain aspects of a personalized business information orchestration, in accordance with certain embodiments of the present disclosure.

FIG. 7 illustrates a functional block diagram of certain aspects of personalized business information orchestration, in accordance with certain embodiments of the present disclosure.

FIGS. 8A, 8B, 8C, 8D, and 8E are screenshots illustrating example end-user interfaces, in accordance with certain embodiments of the present disclosure.

FIG. 9 is a screenshot illustrating an example end-user interface, in accordance with certain embodiments of the present disclosure.

FIG. 10 is a screenshot, which may be a partial screenshot, of an end-user interface that may be displayed after navigating/drilling down into a collaborative collection, in accordance with certain embodiments of the present disclosure.

FIG. 11 is an example of sharing collection information via social/business networking services account postings, in accordance with certain embodiments.

FIG. 12 is a screenshot, which may be a partial screenshot, of a public profile that may be displayed after selection of a link made available with posting, in accordance with certain embodiments.

FIG. 13 is a screenshot, which may be a partial screenshot, of the end-user interface that may be displayed after navigating to another user's public collections, in accordance with certain embodiments.

FIG. 14 is a screenshot, which may be a partial screenshot, of a search interface, in accordance with certain embodiments of the present disclosure.

FIG. 15 is a screenshot, which may be a partial screenshot, of a search interface with business-specific information that may be displayed responsive to user selection, in accordance with certain embodiments of the present disclosure.

FIG. 16 is a screenshot, which may be a partial screenshot, of an end-user interface, in accordance with certain embodiments of the present disclosure.

FIGS. 17A, 17B, and 17C are screen displays illustrating example end-user interfaces, in accordance with certain embodiments of the present disclosure.

FIG. 18 illustrates one embodiment of a merchant dashboard for an advertising platform that may correspond to a provider interface, in accordance with certain embodiments of the present disclosure.

FIG. 19 depicts a functional block diagram of certain aspects of end-user qualification, in accordance with certain embodiments of the present disclosure.

FIG. 20 depicts a functional block diagram of certain aspects of end-user data capture, analytics, and qualification, in accordance with certain embodiments of the present disclosure.

FIG. 21 illustrates one embodiment of an offer manager for an advertising platform that may correspond to a provider interface, in accordance with certain embodiments of the present disclosure.

FIG. 22 is a diagram of an exemplary environment with which embodiments may be implemented, in accordance with certain embodiments of the present disclosure.

FIG. 23 is a diagram of an embodiment of a special-purpose computer system, in accordance with certain embodiments of the present disclosure.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Various embodiments according to the present disclosure may provide for windowing of business information on one or more of geographical, temporal, demographical, and/or social/business networking bases. Certain embodiments may provide an easy way for consumers to find and discover the best local merchants. Certain embodiments may allow consumers to see which local merchants are popular and trusted around them. Searching by a consumer may become more relevant and personalized to the consumer's history and business interests. Certain embodiments may provide one or more ways in which a user may organize the user's business relationship information and may automatically manage, update, and maintain relationship information in order to make the user's life a lot easier. Various embodiments may allow consumers to create and curate business information collections, add custom content to collections, get updates from the businesses of interest, see friends' recommendations, and see what businesses are trending in the consumer's local area(s) of interest.

A user's personalized business information may be retained in/with a local graph of merchants of interest to the user. Certain embodiments may allow for generating a local graph of merchants, organizing the local graph, augmenting the local graph, updating the local graph, exposing the local graph to the user, and/or sharing of the local graph with one or more third parties, which may include one or more other users. Certain embodiments may allow saving of listings information into one or more collections, and certain embodiments may automatically organize a user's listings into collections. By saving of listing information for later use, a user may readily retrieve listing information for businesses of interest. Certain embodiments may allow a user to retrieve the user's personalized business information from any suitable network-connected computing device so that the information is accessible to the user wherever the user may be.

In some embodiments, organization of business information into collections may be based on default criteria and/or user-specified criteria. As some potential non-limiting examples of collections, there may be a home collection, a garden collection, a pet collection, a family collection, a health collection, a kids collection, a collection customized to a specific project, etc. A collection may allow for retrieval of listings at any time.

Business listing information associated with a collection may be automatically updated by the information handling system such that, when listing information is retrieved from a collection, the listing information may be updated information. Thus, a collection allows for the maintenance of listing information of interest to provide a user with the most up-to-date listing information for the businesses that matter to the user. And, thus, if a provider associated with a collection has moved or changed phone numbers, the user will not be left with obsolete information (as the user would otherwise be if such information was recorded into an address book) because the change may be captured so that the collection would be automatically updated with the new information.

Certain embodiments may provide an automated workflow to gauge a user's interests. The automated workflow may include a series of questions presented to the user, the answers to which, as provided by user selections, may indicate user interests. A user's interests may be used as one or more bases for prompting the user according to various embodiments disclosed herein.

Certain embodiments may provide the option for a user to create a custom collection. For example, a user could create a custom collection for a kitchen remodeling project. Providers that are helping, and/or could potentially help, the user with the project could be associated with the collection, with notes on them, indicia of whether the user likes particular providers or not, which providers have been contacted, information obtained from providers, which providers have been selected, etc.

A collection may allow for addition of notes by a user to a listing or a group of listings in the collection. Some embodiments could provide a preference indication feature and/or a rating feature for a user to rate a provider. The preference indication feature could include a user-selectable option allowing a user to indicate a preference for a provider in any suitable manner. The rating feature could include a user-selectable option presenting ratings for selection in any suitable manner.

Thus, a user can record notes about what might be interesting to the user. For example, the user may note having talked to so-and-so, and may generally keep track of various things related to one or more businesses of interest. For example, a user may be planning a project, say a kitchen remodeling project, and may wish to keep track of various aspects related to the project, such as impressions, progress, schedules, ideas, interactions, quotes, deals, and so forth, so that it is all in one place.

Certain embodiments may provide a user with reminders about various aspects of a collection, such as deals and offers, schedule reminders, how long it is been since the user interacted with a given business, whether the user needs to check in with a given business, and/or the like. Certain embodiments may help a user track interactions with businesses. Where the user has been and/or has not been recently may be tracked, for example. For example, the user's last interaction, whether it be a visit or otherwise, with a given restaurant could be tracked and logged with the business information for the restaurant in a particular collection. Such aspects could be managed for the user. As another example, a user's interaction with one or more dentists could be managed, such as the user's last cleaning, when the user was last searching for dentists, etc., and, based on such information, reminders and/or suggestions (such as other possible dentists of interest, for example, highly rated dentists in an area of interest to the user that the user may not have considered and which may have special offers) could be presented.

Certain embodiments may provide the option for a user to allow one or more collaborators to have access to a collection. A collaborator could be another user in some embodiments. An enlist option could be presented to the user to allow the user to enlist another user as a collaborator. A collaborator could have a viewing access and, in some embodiments, editing access and/or access to add content such that the collaborator may add notes, photos, preference indicia, ratings indicia, etc. Some embodiments may allow the user to determine a level of access granted to a collaborator. Certain embodiments may provide the option for a user to share a collection with a third party. Accordingly, the various embodiments directed to information sharing may facilitate organization and engagement with a local business community.

Certain embodiments may provide significant value to businesses through enabling a direct, but low-maintenance, relationships with consumers. Significant value to businesses may also be provided via a business platform that exposes market and consumer insights. Certain embodiments may provide businesses with visibility into their consumers and may provide an easy way to communicate and market to their customers, for example, by marketing events, pushing offers to customers, driving awareness of new products and services, responding to inquiries, etc. Embodiments may provide multiple customer touch points, which, in turn, may allow for better metrics and targeting.

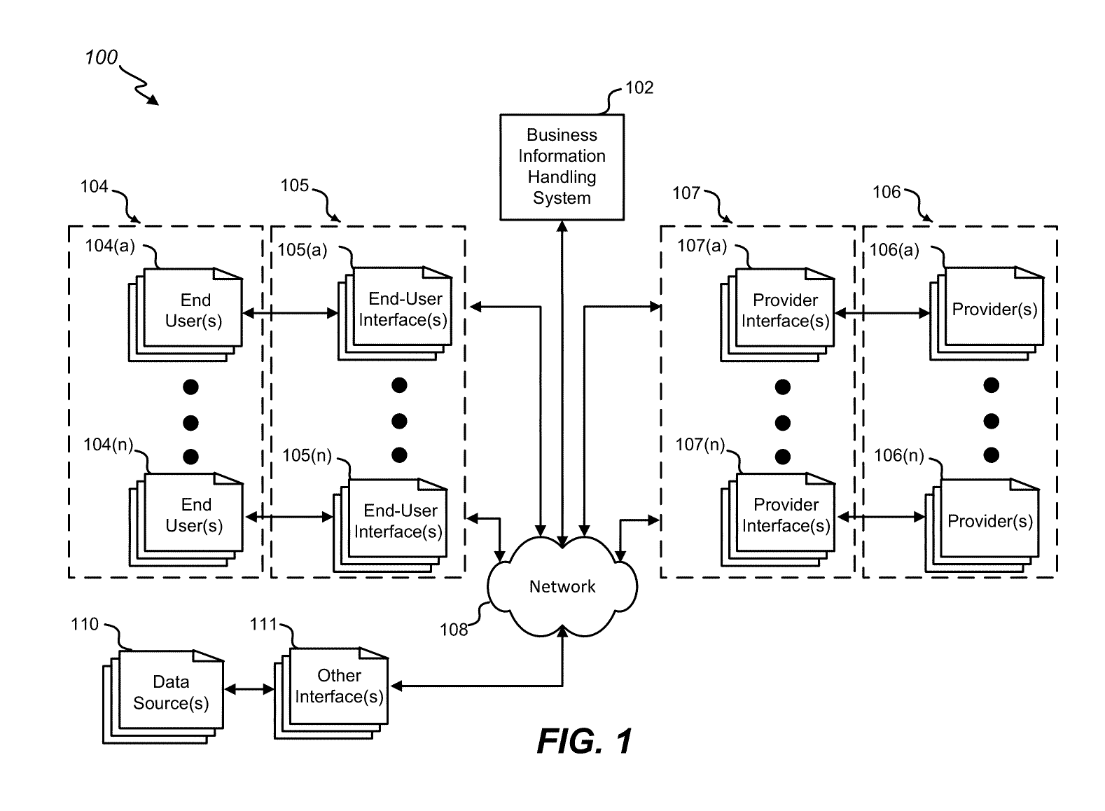

Various embodiments will now be discussed in greater detail with reference to the accompanying figures, beginning with FIG. 1.

FIG. 1 depicts a high-level block diagram of a system 100, in accordance with certain embodiments of the present disclosure. The system 100 may allow for transfer of information from and/or to a business information handling system 102 and an end user 104. An end-user 104, in some embodiments, may correspond to a consumer of products, services, and/or information. In some embodiments, system 100 may also allow for transfer of information from and/or to one or more providers 106 and/or one or more data sources 110. A provider 106, in various embodiments, may correspond to (and may be variously referenced herein by) any one or combination of a service provider, a product provider, a merchant, a business, an advisor, a representative, an advertiser, and/or the like. As depicted, the providers 106 may be communicatively coupled or couplable to a network 108 through one or more service provider interfaces 105.

The network 108 may be any suitable means to facilitate data transfer in the system 100. In various embodiments, the network 108 may be implemented with, without limitation, one or more of the Internet, a wide area network (WAN), a local area network (LAN), a wireless local area network (WLAN), a metropolitan area network (MAN), a cellular network, such as through 4G, 3G, GSM, etc., another wireless network, a gateway, and/or any other appropriate architecture or system that facilitates the communication of signals, data, and/or message. The network 108 may transmit data using any suitable communication protocol. The network 108 and its various components may be implemented using hardware, software, and communications media such wires, optical fibers, microwaves, radio waves, and other electromagnetic and/or optical carriers, and/or any combination of the foregoing. In some embodiments, the network 108 may include a telephone network that may be circuit switched, package switched, or partially circuit switched and partially package switched. For example, the telephone network may partially use the Internet to carry phone calls (e.g., through VoIP).

The business information handling system 102 may be communicatively coupled or couplable to the network 108. In various embodiments, the business information handling system 102 may include any device or set of devices configured to compute, process, organize, categorize, qualify, send, receive, retrieve, generate, convey, store, display, present, detect, handle, and/or use any form of information and/or data suitable for embodiments described herein. The business information handling system 102 could include a single computing device, a server, for example, or multiple computing devices, which may be implemented in or with a distributed computing and/or cloud computing environment with a plurality of servers and cloud-implemented resources. Thus, the business information handling system 102 may include one or more servers. The business information handling system 102 may include one or more processing resources communicatively coupled to one or more storage media, random access memory (RAM), read-only memory (ROM), and/or other types of memory. The business information handling system 102 may include any one or combination of various input and output (I/O) devices, network ports, and display devices.

According to certain embodiments, the business information handling system 102 may be or include a provider management platform. A provider 106 may access the business information handling system 102 via a provider interface 107. An end user 104 may access the business information handling system 102 via an end-user interface 105. The business information handling system 102 may facilitate searching of one or more information repositories in response to information received over the network 108 from the end-user interfaces 105 and/or provider interfaces 107.

The end-user interfaces 105 and/or provider interfaces 107 may allow for transfer of and access to information in accordance with certain embodiments disclosed herein. In various embodiments, the end-user interface(s) 95 and/or service provider interface(s) 97 may include any suitable input/output module or other system/device operable to serve as an interface between a service provider(s) 96 and the provider management platform. The end-user interfaces 105 and/or provider interfaces 107 may facilitate communication over the network 108 using any suitable transmission protocol and/or standard. In various embodiments, the business information handling system 102 may include, provide, and/or be configured for operation with the end-user interfaces 105 and/or provider interfaces 107, for example, by making available and/or communicating with one or more of a website, a web page, a web portal, a web application, a mobile application, enterprise software, and/or any suitable application software. In some embodiments, an end-user interface 105 and/or provider interface 107 may include an application programming interface (API).

In some embodiments, an end-user interface 105 and/or a provider interface 107 may include a web interface. In some embodiments, the end-user interface 105 and/or provider interface 107 may include or work with an application made available to one or more interfaces, such as a mobile application as discussed herein. In some embodiments, the end-user interface 105 and/or provider interface 107 may cause a web page to be displayed on a browser of a service provider 105. The web page(s) may display output and receive input from a user (e.g., by using Web-based forms, via hyperlinks, electronic buttons, etc.). A variety of techniques can be used to create the web pages and/or display/receive information, such as JavaScript, Java applications or applets, dynamic HTML and/or AJAX technologies. Accordingly, the business information handling system 102 may have web site(s)/portal(s) giving access to such information, such as a provider portal.

In various embodiments, an end-user interface 105 and/or a provider interface 107 may include providing one or more display screen images that may each include one or more user interface elements. A user interface may include any text, image, and/or device that can be displayed on a display screen for providing information to a user and/or for receiving user input. A user interface may include one or more widgets, text, text boxes, text fields, tables, grids, charts, hyperlinks, buttons, lists, combo boxes, checkboxes, radio buttons, and/or the like.

In certain embodiments, an end-user interface 105 and/or a provider interface 107 may include a computing device of an end user 104 and/or a service provider 105. In certain embodiments, a provider interface 107 may include a mobile computing device that may be any portable device suitable for sending and receiving information over a network in accordance with embodiments described herein. For example without limitation, in various embodiments, the computing device may include one or more devices variously referenced as a desktop computer, mobile phone, a cellular telephone, a smartphone, a handheld mobile device, a tablet computer, a web pad, a personal digital assistant (PDA), a notebook computer, a handheld computer, a laptop computer, and/or the like.

According to certain embodiments, the business information handling system 102 may be or include an advertising platform. As previously noted, one or more providers 106 may correspond to one or more advertisers. In some embodiments, the business information handling system 102 may provide for the selection and provision of advertisements to one or more end-user interfaces 105. In certain embodiments, providers 106 may have advertisements that may be placed in a web page made available to one or more end-user interfaces 105. In certain embodiments, providers 106 may have advertisements that may be displayed with an application made available to one or more end-user interfaces 105, such as a mobile application according to various embodiments. In some embodiments, placement of the advertisements could be in accordance with one or more paid placement arrangements and one or more advertising models.

Advertisements may be included in a results page responsive to a keyword search initiated by an end user 104 via, for example, a webpage and/or a mobile application. The search may be performed by an online search engine facilitated by the business information handling system 102. An advertisement of provider 106 may be included within a results page with results identified and/or compiled by the search engine and sent via the network 108 to the end-user interface 105 of the end user 104 that initiated the search.

In certain embodiments, the business information handling system 102 may be communicatively coupled or couplable to one or more data sources 110. The one or more data sources 110 may include any suitable source of data. In various embodiments, a data source 110 may include any one or more or combination of a database, a website, any repository of data in any suitable form, and/or a third party. In various embodiments, the one or more data sources 110 may correspond to one or more social media websites and/or photo-sharing websites.

According to certain embodiments, data may be actively gathered and/or pulled from data sources 110, for example, by accessing/crawling a data source repository. In various embodiments, the data from the one or more data sources 110 may be retrieved and/or received by the business information handling system 102 via the network 108 and/or through any other suitable means of transferring data. For example, in some embodiments, the business information handling system 102 and the data sources 110 could use any suitable means for direct communication. Other interface(s) 111 may facilitate communication with data source(s) 110, and, in various embodiments, may be implemented in similar manner to interfaces 105 and/or 107 or any other suitable interface.

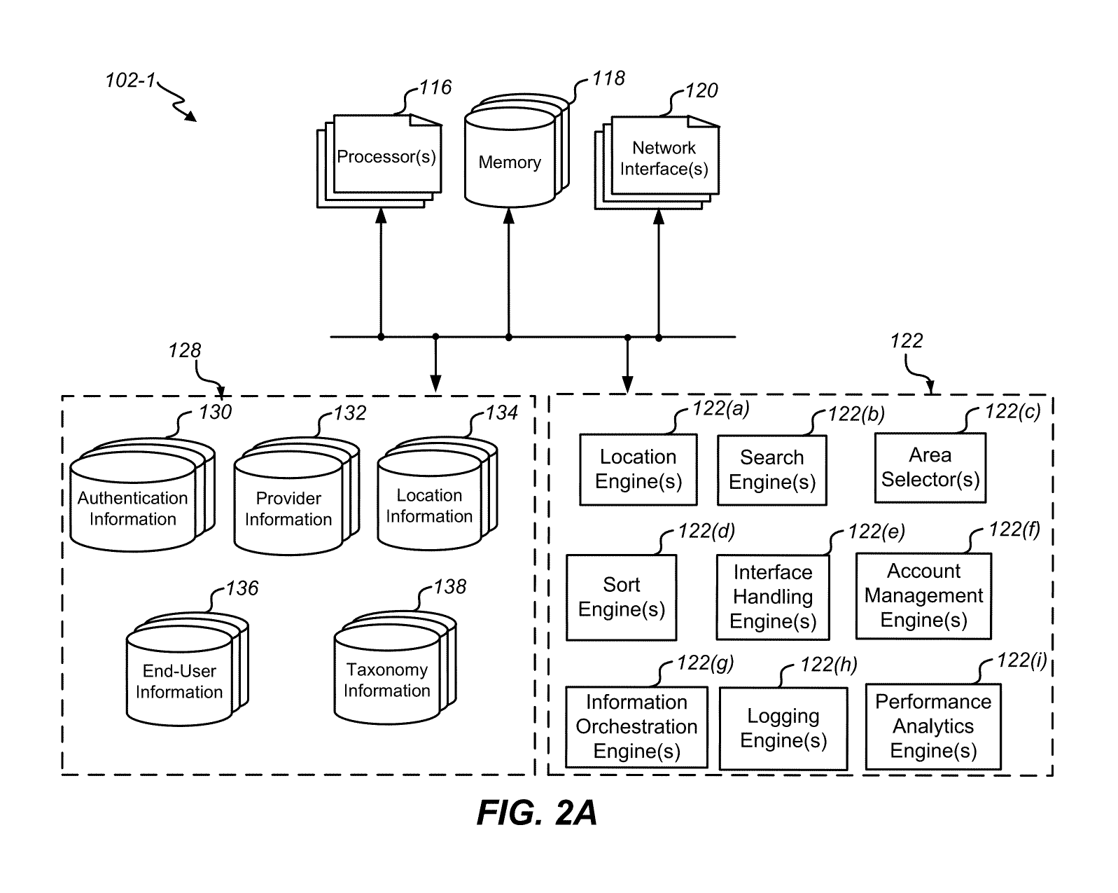

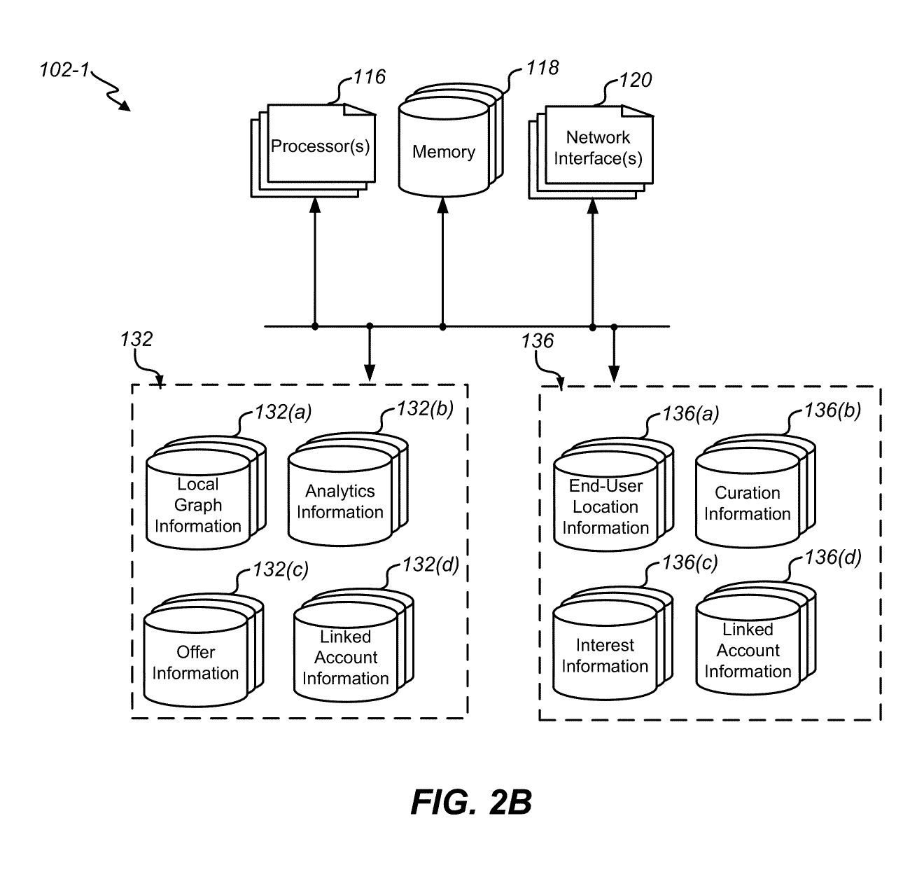

FIGS. 2A and 2B show high-level block diagrams of a business information handling system 102-1, in accordance with certain embodiments of the present disclosure. The business information handling system 102-1 may correspond to the business information handling system 102 of FIG. 1, but one embodiment of the business information handling system 102 is shown in more detail. While engines, modules, repositories, and other components are described separately herein, it should be appreciated that the components may be combined and/or implemented differently in any combination to provide certain features in various embodiments. In various embodiments, different processes running on one or more shared computers may implement some of the components.

As depicted, the business information handling system 102 may include one or more processors 116 communicatively coupled to one or more memories 118. The business information handling system 102 may include one or more network interfaces 120 communicatively coupled to processors 116. In certain embodiments, one or more processors 116, one or more memories 118, and/or one or more network interfaces 120 may correspond to one or more servers, which may include communication servers, web servers, gateways, application servers, database servers, and/or one or more other types of servers. In certain embodiments, the business information handling system 102 may be implemented in or with a distributed computing and/or cloud computing environment with a plurality of servers and cloud-implemented processing, memory, and data resources. Thus, with accretion of service information, the system may allow for scaling out with additional processing resources, server resources, data storage resources, data management resources, and the like. Some embodiments may use different types of servers to service different types of computing devices. The network interface(s) 120 may include any suitable input/output module or other system/device operable to serve as an interface between one or more components of the business information handling system 102 and the network 108. The business information handling system 102 may use the network interfaces 120 to communicate over the network 108 using any suitable transmission protocol and/or standard.

In some embodiments, one or more servers may communicate via one or more types of communication protocols, such as HyperText Transfer Protocol (HTTP), File Transfer Protocol (FTP), Wireless Application Protocol (WAP), etc. A server may provide static web pages, dynamic web pages, web services, web applications to a computing device of an end user or provider for execution in a web browser running on the computing device, scripts for execution within an isolated environment in a browser, and/or rich-client applications to the computing device that may have access to functions of the operating system running on the computing device.

Certain embodiments may provide a multi-channel communication regime to coordinate multiple communication channels used by end users and providers. Multiple communication pipes within a communication pipe could be implemented according to certain embodiments. Some embodiments may implement a greater number of communication channels. For example, one set of channels could be used for a consumer to request help, and one set of channels could be used for a provider to respond to the end user. The system can use web communication, text communication, voice communication, e-mail communication, push notification, and/or the like.

The business information handling system 102 may include one or more data repositories 128. One or more data repositories 128 may retain any information suitable for embodiments of this disclosure. The data repositories 128 may include database(s), database management system(s), server(s) to facilitate management/provision/transfer of information related to embodiments of this disclosure. In various embodiments, the data repositories 128 may be implemented in various ways. For example, one or more relational or object-oriented databases, or flat files on one or more computers or networked storage devices, may store the information. It should be appreciated that information corresponding to the repositories may be stored elsewhere and/or in other ways, or may not be stored, depending on the implementations chosen. Likewise, while various segregations of information corresponding to the repositories are provided herein, it should be appreciated that such examples are non-limiting, and some or all the information may be handled in any suitable manner.

In some embodiments, the one or more data repositories 128 may include one or more authentication information repositories 130 may retain any authentication information suitable to facilitate security for embodiments of this disclosure. The authentication information repositories 130 may include database(s), database management system(s), server(s) to facilitate management/provision/transfer of authentication information, and/or the like. The repositories 130 may retain authentication information of one or more particular end users 104, providers 106, and/or other data sources 110. The authentication information may include information to check credentials of end users 104, providers 106, and/or other data sources 110 that may use one of their corresponding interfaces to seek access, transfer information, and/or make business-related transactions with business information handling system 102. The authentication information may be used to provide security for transactions, restrict the access granted to a certain set of information and/or features, implement certain control and/or features for certain parties, and/or the like.

The one or more data repositories 128 may include one or more provider information repositories 132. The one or more provider information repositories 132 may retain provider information of particular providers 106. The repositories 132 may retain any information related to providers, including businesses and people, which may have street addresses or other location parameters, such as longitude and latitude coordinates, maps, driving directions, and/or the like, stored as locations in one or more location information repositories 134. For example, one or more provider information repositories 132 may retain any information related to provider identification information, provider profiles, provider certification information, business description, product descriptions, service descriptions, ratings/reviews/comments/preference indicia associated with providers, provider websites, provider pricing information, provider authentication information, provider statuses, provider relationships, organization details, payment methods, accounting information, credit information, asset information, collateral information, address information, contact information, business hours, availability, user account information, advertisements, announcements, and/or the like.

As illustrated in FIG. 2B, provider information may include local graph information 132(a). The local graph information 132(a) may include mapping information about a provider's connections to collections, windows, end users, and/or the like via the orchestration service. The local graph information 132(a) may include classification information about a provider and relation to user interest data and business categories. Generally, the local graph information 132(a) may include any information to facilitate provider inclusion in the orchestration platform in accordance with various embodiments described herein.

Provider information may include analytics information 132(b). The analytics information 132(b) may include any performance information related to particular providers, including any end-user data analytics related to particular providers. Provider information may include offer information 132(c) retained for particular providers. The offer information 132(c) may include offers that particular providers have created, business rules associated with provisioning offers to end users, and/or the like. Provider information may include linked account information 132(d). The linked account information 132(d) may include information about a provider's account(s) that are linked with the orchestration system, such authentication information for linked accounts, which accounts may include email accounts, short messaging accounts, online social/business networking accounts, and/or the like. The analytics information 132(b), the offer information 132(c), and the linked account information 132(d) may include any information to facilitate various features of one or more provider interfaces, in accordance with certain embodiments herein.

In some embodiments, the one or more data repositories 128 may include one or more end-user information repositories 136 to retain any suitable information associated with users in accordance with various embodiments disclosed herein. The end-user information may include end-user identification information, payment methods, accounting information, contact information, user account information, and/or the like. One or more end-user information repositories 136 may retain any information related to end-user location information 136(a), curation information 136(b), interest information 136(c) related to end user (which may include information related to indicia of interest), linked account information 136(d), and/or the like. The curation information 136(b) may include local graph information, which may include information about providers of interest, providers that have been added to a user's collection, geo-specific criteria for end user collections/profile, business information otherwise associated with the end user (which may include collection followings, e.g.), notes by the end user, photos and/or other images associated with the end user, preferences of the end user, arrangement/organizational particulars for business information associated with the end user, end-user requests, and/or any suitable information to facilitate any one or combination of the personal curation features described herein. The linked account information 136(d) may include information about an end user's account(s) that are linked with the orchestration system, end-user notification profiles, end-user authentication information, and/or any information to facilitate various features of one or more end-user interfaces, in accordance with certain embodiments herein.

In some embodiments, a computing device 105 may store end-user information 136. In some embodiments, both the computing device 105 and the online data repository(ies) 128 store the end-user information 136 for a particular end user 104. In some embodiments, when there is a data communication connection between the computing device 105 and the online data repository(ies) 128, the computing device 105 and the online data repository(ies) 128 may synchronize their copies of the end-user information 136 for the end user 104.

Referring again to FIG. 2A, the provider information 132 may be associated with locations 134. In various embodiments, the locations 134 may be part of the service provider information 132, or otherwise associated therewith. In some embodiments, the one or more data repositories 128 may include one or more taxonomy information repositories 138 to retain any suitable information associated with taxonomy feature in accordance with various embodiments disclosed herein. For example, one or more taxonomy information repositories 138 may retain mapping information, classification information, scoring criteria, and/or the like. Information retained in one or more taxonomy information repositories 138 may be used to classify user interest data/indicia, classify businesses, map user interests, businesses, and/or interest categories, and/or otherwise correlate and organize information in accordance with various embodiments disclosed herein.

The business information handling system 102 may include one or more information management handling engines 122 that may be stored in one or more memories 118 and may provide functionality when executed by one or more processors 116 to provide enhanced service provider handling features described herein. While the engines 122 are shown separately, it should be appreciated that in various embodiments the one or more engines 122 may be implemented collectively and/or integrally. The engines 122 may be configured to perform any of the steps of methods described in the present disclosure.

In some embodiments, one or more of the engines 122 and/or other modules may be servers communicating with the server(s). The server communication may be over a network, such as a local area network, a wide area network, an intranet, Internet, and/or the like. Any one or combination of the various servers may run on common or separate computers. In some embodiments, there may be one or more layers of application servers between communication servers and the data repository(ies) 128 to process the business logic and data access of the rich client applications. Alternatively, application servers may be integrated with the communication servers.

In some embodiments, one or more servers may provide listings information 132 with links to detail information, such as a map, business hours, driving directions, etc. The server(s) may provide user interfaces for the users to rate the listings information 132, provide reviews, view reviews from other users, make reservations via the listings information 132, make purchases via the listings information 132, etc. The server(s) can track various different types of user interactions with the listings to determine or estimate the level of user interest in the listings. The servers may provide rich client applications for execution in the mobile computing device to provide the user interfaces. The server(s) may be communicatively coupled to one or more of a location engine(s) 122(a), a search engine(s) 122(b), an area selector(s) 146(c), and/or a sort engine(s) 146(d) to process the search request and present search results based on the information stored in one or more data repositories 128.

In some embodiments, the location engine(s) 122(a) may include one or more engines and may use GPS coordinates, cellular tower triangulation techniques, Wi-Fi-based location information, carrier-provided location information, and/or other location determination systems to identify a location of the computing device 105. In some embodiments, the location engine 122(a) determines a location of interest to the end user 104 related to a search request. The location of interest may be based on a location of the computing device 105. In some embodiments, the end user 104 may explicitly specify the location of interest in a search request; and the location engine 122(a) extracts the location of interest from the search request. In some embodiments, a location of interest may be based on end-user information stored for a particular end user 104 and associated with identification information of the end user 104 or the computing device 105. In some embodiments, the end user 104 may specify some or all of the end-user information.

In some embodiments, the location engine 122(a) may automatically identify the location of interest based on determining the current location of the computing device 105 that is used to submit a search request and/or initiate a phone call. For example, the location engine 122(a) may determine the location of the computing device 92 based on a connection point the computing device 105 used to access the network 108 (e.g., based on the location of a wireless network access point, a base station of a cellular communication system, or a connection point to a wired network). In some embodiments, the computing device 105 automatically determines its current position (e.g., via a satellite positioning system, or a cellular positioning system) and transmits the determined or estimated position to the system 102 with the search request, or provides the position in response to a request from the location engine 122(a).

In some embodiments, the search engine 122(b) may retrieve information from the data repository(ies) 123 according to a search request. The search engine 122(b) may include logic for implementing searching of one or more information repositories. Other engines 122 may include and/or utilize the search engine 122(b) in various embodiments. The searching may be in response to information received over the network 94 from a user. Responsive to a query, the search engine 122(b) may search, retrieve, modify, and/or cause transfer of particular information from one or more information repositories.

The sort engine 122(c) may rank the information according to various bases discussed with embodiments herein. In various embodiments, the area selector 122(d) may be configured to select areas of interest in accordance with various embodiments described herein. In some embodiments, the area selector 122(d) may select a first geographic area based on the location of interest identified by the location engine 122(a). The search engine 122(b) may then retrieve a first set of service provider information that have corresponding locations within the selected first geographic area and that satisfies the search criteria, and, if sufficient results are not found for the first geographic area, a second geographic area may be selected in an iterative process, which second area may or may not include the first geographic area, for searching. In some embodiments, the search engine 122(b) may search for service provider information in a target area to obtain a set of search results; the area selector 122(d) may select geographic areas and may select groups of results that are within the selected geographic areas respectively.

In some embodiments, the interface handling engine(s) 122(e) may include logic to send, present, and receive information, with one or more of the interfaces to/from one or more consumers, service providers, and/or data sources. The interface handling engine(s) 122(e), with one or more the processors 116, may utilize one or more network interfaces 120 to transceive information through the network 108. The system 102 may pull and/or push information from those entities in any suitable way.

In some embodiments, the account management engine(s) 122(f) may include logic for implementing account features in various embodiments. By way of example without limitation, the account management engine(s) 122(f) may include logic one or more aspects of: handling user registration; managing account creation, updates, authentication, handling; and/or the like. The account management engine(s) 122(f) may be configured for acquiring, processing, formatting, and/or storing authentication information in the one or more authentication repositories 128.

In some embodiments, the information orchestration engine(s) 122(g) may include logic for implementing any features of personalized orchestration of business information in various embodiments disclosed herein. In some embodiments, the information orchestration engine(s) 122(g) may facilitate an application on the end-user device to provide any such features. In some embodiments, the information orchestration engine(s) 122(g) may be incorporated in the application. In some embodiments, the information orchestration engine(s) 122(g) may include logic to implement and/or otherwise facilitate any taxonomy, classification, categorization, correlation, mapping, qualification, scoring, organization, and/or the like features discussed herein. The information orchestration engine(s) 122(g) may include interest data analytics modules may include logic to retrieve, process, derive, compile, aggregate, handle, store, report, and/or present information relating to interest data. In certain embodiments, the information orchestration engine(s) 122(g) may be configured to compile keyword criteria, for example, in an ontology, and could include an ontology reasoner or semantic reasoning module to make logical inferences from a set of facts in the ontology. Accordingly, the information orchestration engine(s) 122(g) may correspond to a reasoning engine configured to effect one or more features discusses herein. A pattern-based reasoner could be employed to use various statistical techniques in analyzing interest data in order to make inferences based on the analysis. A transitive reasoner could be employed to infer relationships from a set of relationships related to interest data. In certain embodiments, the information orchestration engine(s) 122(g) may include logic for implementing workflow features in various embodiments.

In some embodiments, the logging engine(s) 122(h) may include logic for implementing information logging features in various embodiments. By way of example without limitation, the logging engine(s) 122(h) could process data pulled and/or pushed from various entities. The logging engine(s) 122(h) could handle process, extracting, formatting, and/or storing/recording data including data for indicia of interest, preference data, taxonomy data, mapping data, and/or the like.

In some embodiments, one or more end-user data analytics engines 122(i) may include logic to retrieve, process, derive, compile, aggregate, handle, store, report, and/or present information relating to end-user data. The performance analytics engine(s) 122(i) may be configured to present any desirable information in any desirable manner. With respect to a particular provider, the logging engine(s) 122(h) and end-user data analytics engine(s) 122(i) may facilitate various features of one or more provider interfaces, in accordance with certain embodiments herein (e.g., interfaces 1800, 2100).

In some embodiments, one computer system implements one or more of the components of the system 102. Alternatively, different processes running on one or more shared computers may implement some of the components. For example, one computing module, thread, or process may implement multiple of the components. In some embodiments, special purpose data processing systems implement the one or more of the components. In some embodiments, processes running according to software instructions on general purpose data processing systems, such as general purpose personal computers or server computers, can implement the components. Thus, the implementations are not limited to particular hardware, software, or particular combinations of hardware and software.

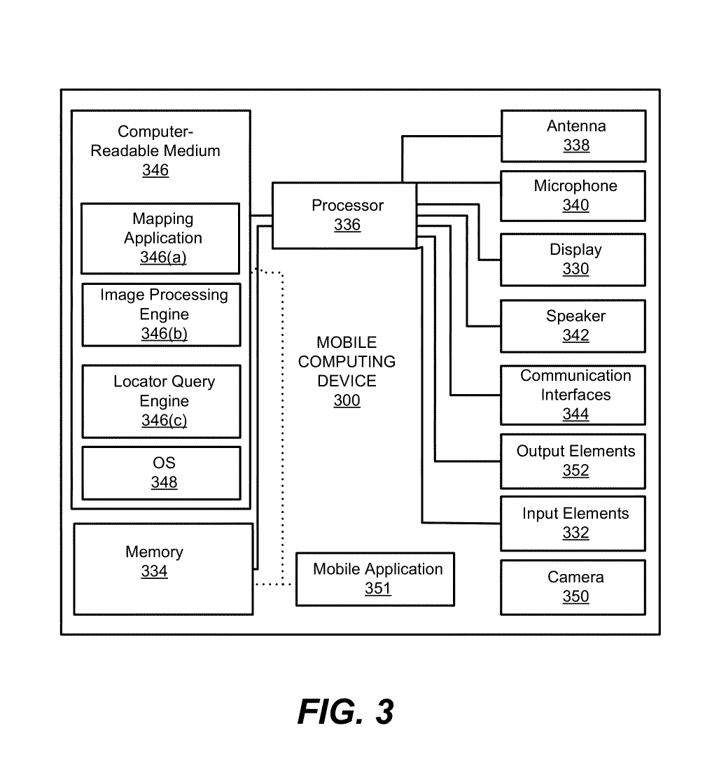

FIG. 3 is a functional block diagram of a mobile computing device 300, which may correspond to one or more of interfaces 105, 107, and/or 111, according to certain embodiments of the present disclosure. In some embodiments, the mobile computing device 300 may be provided with a mobile application 351 configured to run on the mobile computing device 300 to facilitate various embodiments of this disclosure. The mobile computing device 300 may be any portable device suitable for sending and receiving information over a network in accordance with embodiments described herein. For example without limitation, in various embodiments, the mobile computing device 300 may include one or more variously referenced as a mobile phone, a cellular telephone, a smartphone, a handheld mobile device, a tablet computer, a web pad, a personal digital assistant (PDA), a notebook computer, a handheld computer, a laptop computer, a vehicle computer, or the like.

As shown in FIG. 3, the mobile computing device 300 includes a display 330 and input elements 332 to allow a user to input information into the mobile computing device 300. By way of example without limitation, the input elements 332 may include one or more of a keypad, a trackball, a touchscreen, a touchpad, a pointing device, a microphone, a voice recognition device, or any other appropriate mechanism for the user to provide input. The mobile computing device 300 includes a memory 334 communicatively coupled to a processor 336 (e.g., a microprocessor) for processing the functions of the mobile computing device 300. The mobile computing device 300 may include at least one antenna 338 for wireless data transfer.

The mobile computing device 300 may also include a microphone 340 to allow a user to transmit voice communication through the mobile computing device 300, and a speaker 342 to allow the user to hear voice communication, music, etc. In addition, the mobile computing device 300 may include one or more interfaces in addition to the antenna 338, e.g., a wireless interface coupled to an antenna. The communications interfaces 344 can provide a near field communication interface (e.g., contactless interface, Bluetooth, optical interface, etc.) and/or wireless communications interfaces capable of communicating through a cellular network, such as GSM, or through Wi-Fi, such as with a wireless local area network (WLAN). Accordingly, the mobile computing device 300 may be capable of transmitting and receiving information wirelessly through both short range, radio frequency (RF) and cellular and Wi-Fi connections.

Additionally, the mobile computing device 300 can be capable of communicating with a Global Positioning System (GPS) in order to determine to location of the mobile computing device 300. In the embodiment shown in FIG. 3, the antenna 338 may include a cellular antenna (e.g., for sending and receiving cellular voice and data communication, such as through a network such as a 3G or 4G network), and interfaces 344 may include one or more local communication interfaces. The antenna 338 may include GPS receiver functionality. In other embodiments contemplated herein, communication with the mobile computing device 300 may be conducted with a single antenna configured for multiple purposes (e.g., cellular, transactions, GPS, etc.), or with further interfaces (e.g., three, four, or more separate interfaces).

The mobile computing device 300 can also include at least one computer-readable medium 346 coupled to the processor 336, which stores application programs and other computer code instructions for operating the device, such as an operating system (OS) 348. The mobile application 351 may be stored in the memory 334 and/or computer-readable media 346. The computer-readable medium 346 can include a mapping application in some embodiments. In certain embodiments, the mapping application 346(a) can automatically run each time that a user accesses the mobile application 351.

The computer-readable medium 346 can also include an image-processing engine 346(b). The image-processing engine 346(b) can capture an image and compress the image in a format readable by a central processing server. With some embodiments, the image-processing engine 346(b) is separate from the mobile application 351. In other embodiments, the mobile application 351 may include the image-processing engine 346(b).

The computer-readable medium 346 on the mobile computing device 336 can also include a locator query engine 346(c), which allows a user to enter a word or phrase to locate an item, location, business, services, etc. With some embodiments, the locator query engine 346(c) is separate from the mobile application 351. In other embodiments, the mobile application 351 may include the locator query engine 346(c).

The mobile computing device 336 can additionally include an integrated camera 350, capable of capturing images and/or video, and output elements 352. In certain embodiments, the mobile computing device 336 may include a non-transitory computer-readable storage medium, e.g., memory 334, for storing images captured with the camera 350. In alternative embodiments, the mobile computing device 336 receives image data from an image capture device that is not integrated with the mobile computing device 336 and stores those images on the aforementioned non-transitory storage medium.

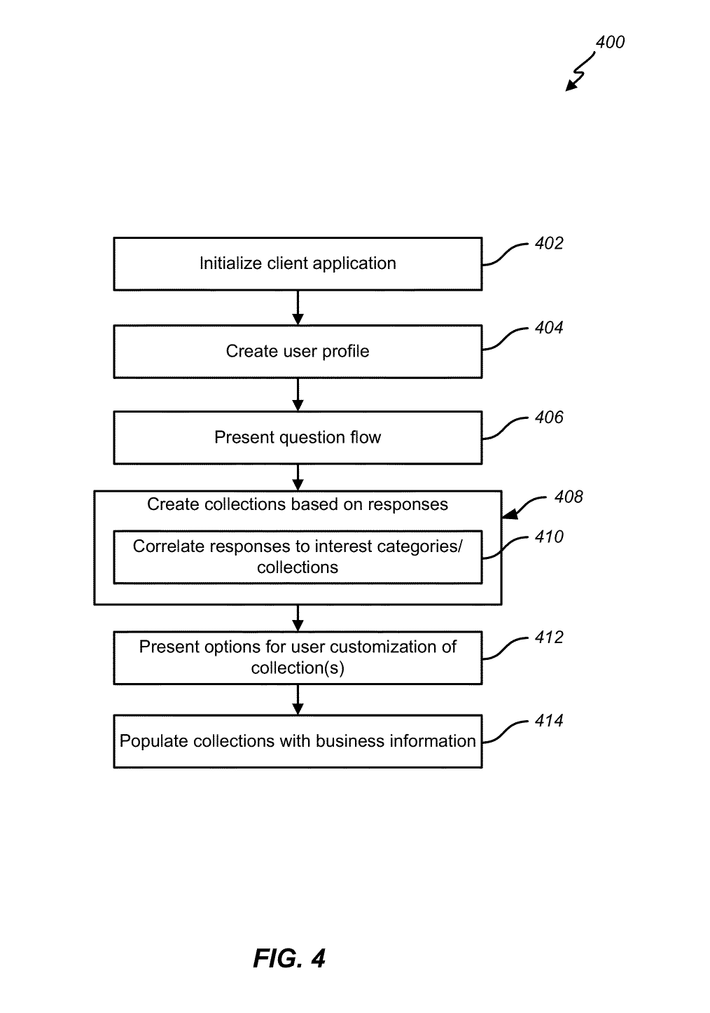

FIG. 4 is a block diagram that illustrates an example method 400 of certain aspects of a personalized business information orchestration, in accordance with certain embodiments of the present disclosure. According to certain embodiments, the method 400 may begin as indicated by block 402. Teachings of the present disclosure may be implemented in a variety of configurations. As such, the order of the steps comprising the method 400 may be shuffled in any suitable manner and may depend on the implementation chosen. Moreover, while the following steps may be separated for the sake of description, it should be understood that certain steps may be performed simultaneously or substantially simultaneously.

One aspect of personalized business information orchestration may correspond to an end-user onboarding phase. The onboarding may include application initialization stage, as indicated by block 402. In some embodiments, the application could correspond to a webpage. In some embodiments, the end user could be using a mobile computing device. In some embodiments, a mobile application configured to run on a mobile computing device may be provided for the end user's mobile computing device. For example, the mobile application may be made available from the system 102 or any website for download to the mobile computing device; alternatively, it may be pre-installed on the mobile computing device and stored in the device's memory and/or computer-readable media. An end user installing a mobile application may correspond to initializing a client application on a computing device in some embodiments.

The end-user interface provided by the platform may facilitate the onboarding phase. In various embodiments, an end-user interface may include providing one or more display screens that may each include one or more user interface elements. An end-user interface may include any text, image, and/or device that can be displayed on a display screen for providing information to a user and/or for receiving user input. An end-user interface may include one or more widgets, text, text boxes, text fields, tables, grids, charts, maps, hyperlinks, buttons, lists, combo boxes, checkboxes, radio buttons, and/or the like.

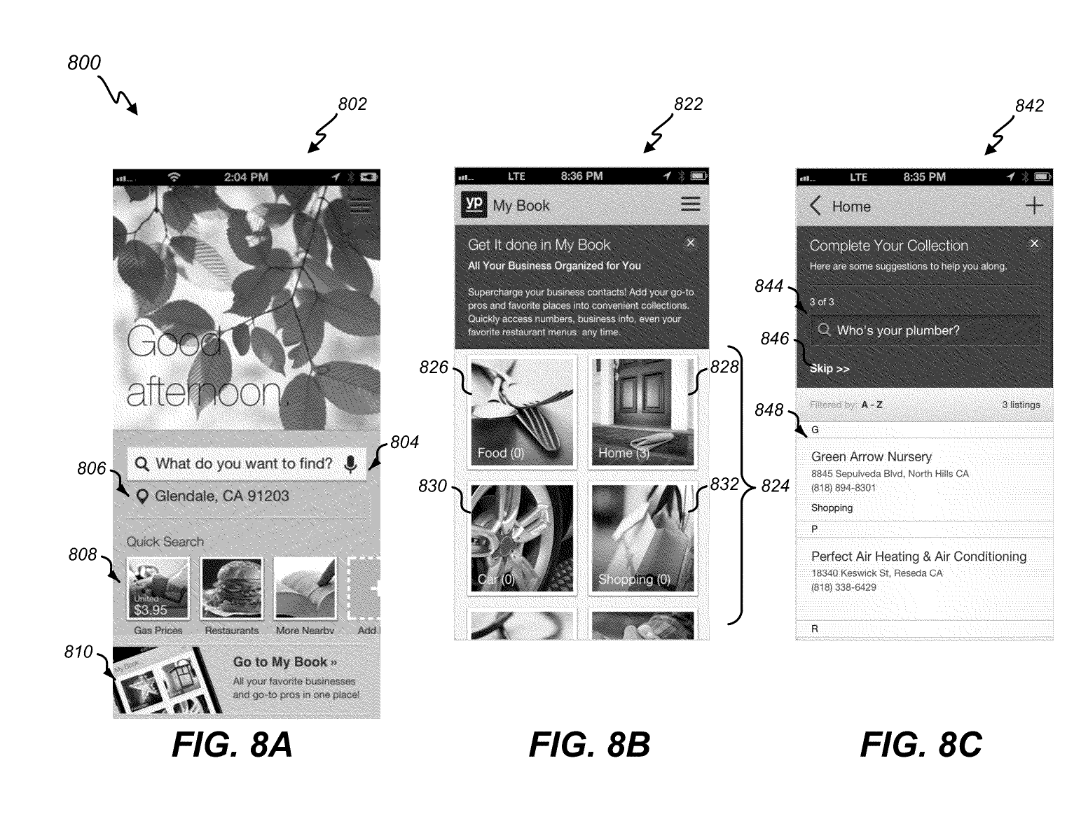

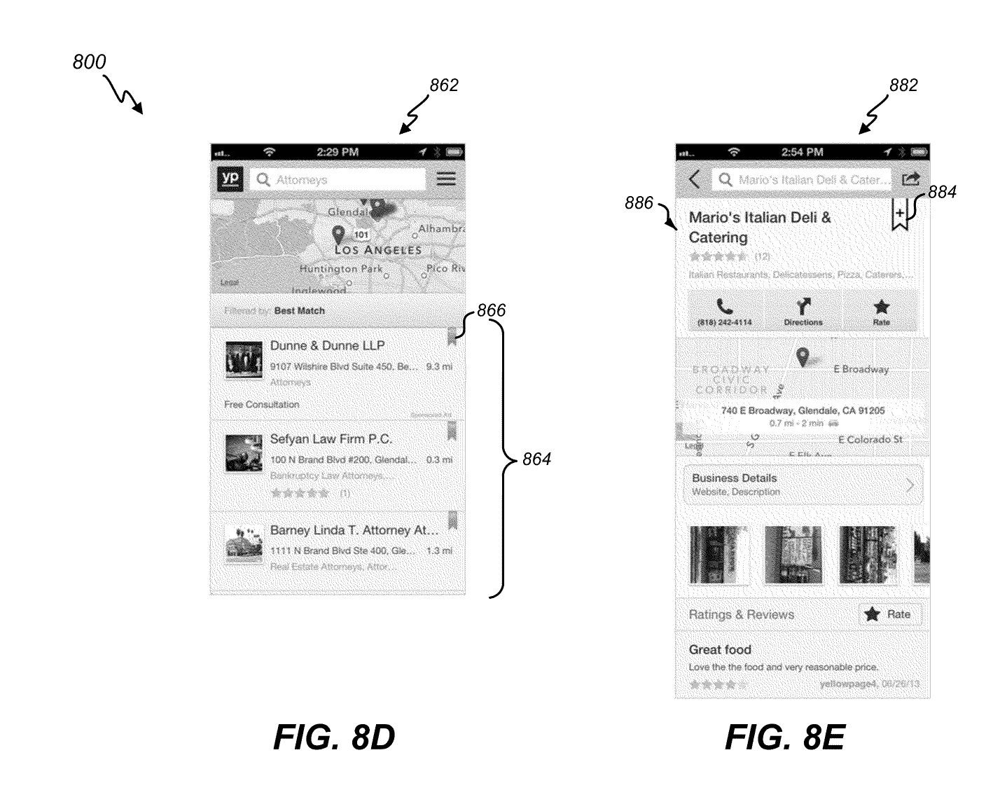

FIGS. 8A, 8B, 8C, 8D, and 8E are screenshots illustrating example end-user interfaces 800, in accordance with certain embodiments of the present disclosure. FIG. 8A illustrates a graphical user interface 802 that may be used in implementations of certain embodiments of the present disclosure. FIG. 8A shows a screenshot, which may be a partial screenshot, of a search interface 802 that may be displayed via a mobile application or any suitable end-user interface 105 in various embodiments. In some embodiments, a webpage could implement a same or similar search interface, for example.

The search interface 802 can be displayed at a user device 300, for example. A query field 804 may be configured for input of keyword information for a search by a user, for example, via text entry and/or voice entry. In some embodiments, the search interface 802 may also include a location field 806 for location information to indicate a location of interest related to the keyword information for the search input by the user, for example, via text entry and/or voice entry. The location field 806 could automatically indicate a default location for the user automatically determined based any suitable location identification method, such as one or more of the location identification methods disclosed herein, including user history, a user profile, and/or the user's current location as detected by GPS, cellular positioning, network access point, and/or the like.

The search interface 802 can present user-selectable options 808 for quick searches according to any suitable category. The search interface 802 can present user-selectable options 810 related to one or more personalized collections of business information. The options 810 could correspond to an initialization process for a user to set up one or more personalized collections of business information; the options 810 could correspond to a navigational feature that enables the user to navigate to one or more personalized collections that have already been set up.

Referring again to FIG. 4, the onboarding phase of personalized business information orchestration may include a user profile stage, as indicated by block 404. A user profile may be created along with initialization of an application or embodiments for along with registering as a user via webpage in some embodiments. The user profile may be created automatically for the user, and user may be able to thereafter customize the profile. A user profile may include persistent information that is maintained about an end user. A user profile may include any data stored in an end-user information repository whether or not it is part of the profile as shown to an end-user via an end-user portal.

A personalized collection utility may include various features for identifying a user's interests. In some embodiments, as indicated by block 406, one or more questions may be presented to the user to gauge a user's interests. In certain embodiments, an automated question flow may present a series of questions presented to the user, the answers to which, as provided by user selections, may indicate user interests.

In some embodiments, organization of business information into collections may be based on default criteria and/or user-specified criteria. As some potential non-limiting examples of collections, there may be a home collection, a garden collection, a pet collection, a family collection, a health collection, a kids collection, a collection customized to a specific project, etc. A collection may allow for retrieval of listings at any time.

FIG. 8B illustrates a graphical user interface 822 for a personalized collection utility that may be used in implementations of certain embodiments of the present disclosure. FIG. 8B shows a screenshot, which may be a partial screenshot, of an interface that may be displayed via a mobile application or any suitable end-user interface 105 in various embodiments. In some embodiments, a webpage could implement a same or similar interface, for example. The personalized collection utility may provide one or more ways in which a user may organize the user's business relationship information. The personalized collection utility may automatically manage, update, and maintain relationship information in order to make the user's life a lot easier. Certain embodiments allow saving of listings information into one or more collections 824, and certain embodiments may automatically organize a user's listings into collections 824. By saving of listing information for later use, a user may readily retrieve listing information for businesses of interest.

In the example depicted, options or various collections 824 are presented, including a food collection option 826, a home collection option 828, a car collection option 830, and a shopping collection option 832. The options may be user-selectable options that enable a user to navigate to business information associated with each collection 824. A collection 824 may allow for retrieval of listings and/or other business-specific information at any time. In some embodiments, certain collection options could be presented to the user as a default, which the user may thereafter customize.

Referring again to FIG. 4, the onboarding phase of personalized business information orchestration may include a collection creation stage, as indicated by block 408. In some embodiments, a default set of collections could be presented to the user. In some embodiments, collection creation could include correlating responses, which were received from the user per the question flow, to interest categories/collections, as indicated by block 410. The most appropriate set of collections determined based on the responses may be suggested to the user, or the application could simply be configured to include the set of collections, and the user may thereafter customize the collections in any suitable manner.

As indicated by block 412, options for customization of collections may be presented to the user. And, as indicated by block 414, the collections may be populated with business information. Certain embodiments may provide the option for a user to create a custom collection. For example, a user could create a custom collection for a kitchen remodeling project. Providers that are helping, and/or could potentially help, the user with the project could be associated with the collection. Features could also be provided to the user to allow the user to make and retain notes related to the project, such as notes on the providers, indicia of whether the user likes particular providers or not, which providers have been contacted, information obtained from providers, which providers have been selected, etc.

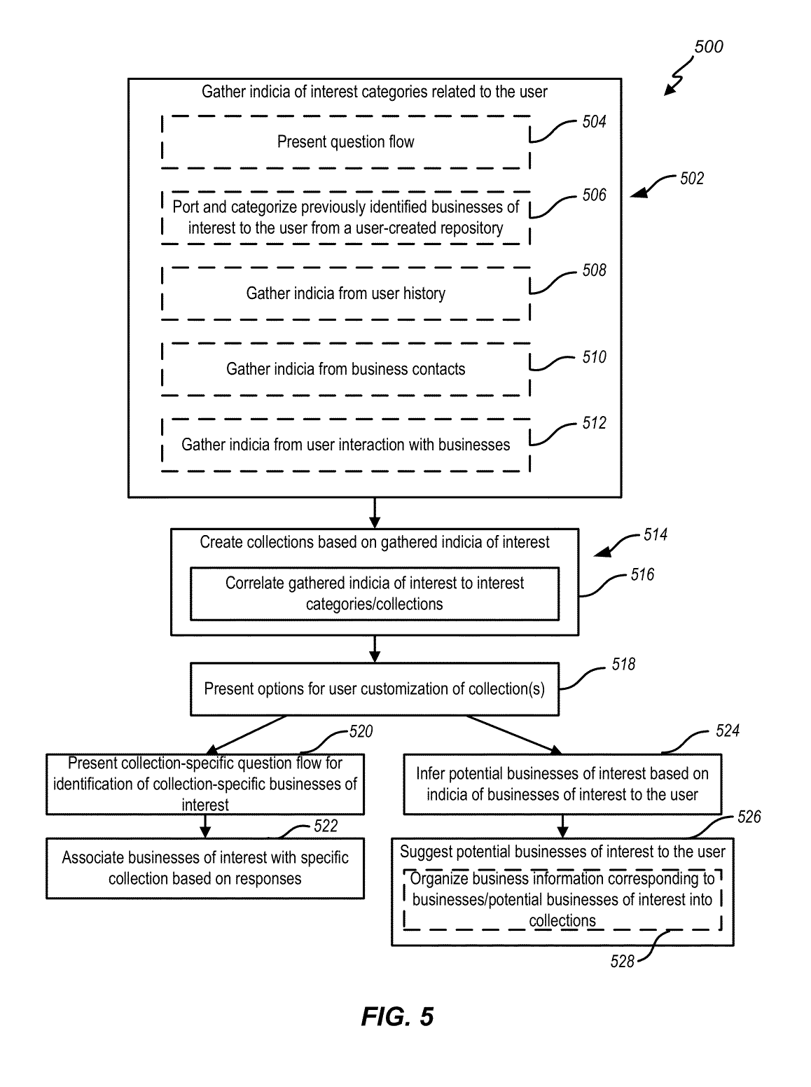

FIG. 5 is a block diagram that illustrates an example method 500 of certain aspects of a personalized business information orchestration, in accordance with certain embodiments of the present disclosure. According to certain embodiments, certain aspects of the method 500 may be implemented in addition to or in alternative to certain aspects of the method 400. As indicated by block 502, indicia of user interests may be gathered. The personalized collection utility may include various features for identifying potential indicia of user interests.

In some embodiments, as indicated by block 504, one or more questions may be presented to the user to gauge a user's interests. This may correspond to block 406 of the method 400. Accordingly, an automated workflow may include a series of questions presented to the user, the answers to which, as provided by user selections, may indicate user interests.

Some embodiments may provide for porting and categorization of previously identified businesses of interest to the user from a user-created repository of information on businesses of interest, as indicated by block 506. Some embodiments may provide for options for user initiation of porting categorizing; some embodiments may perform the process automatically. The application implementing the personalized collection utility may be configured with a plug-in, module, API, and/or otherwise to gather information from the end-user device and/or relate that information to the businesses of potential interest to the user.

In some embodiments, the personalized collection utility may include features for automatically identifying potential businesses of interest to a specific user based at least in part on user history information, as indicated by block 508. A particular user could have a history and/or profile associated with using search features facilitated by the business information handling system 102, for example, via a client application, a webpage, a mobile application, and/or the like. For example, businesses of potential interest may be identified from web browsing history information retained on the user computing device. Not only may businesses associated with the history and/or profile be identified, but also attendant business-specific information may be identified for population of collections. Some embodiments may provide for options for user initiation of gathering indicia from user history information; some embodiments may perform the process automatically.

In some embodiments, the personalized collection utility may include features for automatically identifying potential businesses of interest to a specific user based at least in part on business contacts of the user, as indicated by block 510. Some embodiments may provide for options for user initiation of gathering indicia based on business contacts; some embodiments may perform the process automatically. For example, business contacts retained on the user computing device (such as business contacts in an address book, a phone book, etc.) may be harvested.

Once one or more business contacts are identified based on harvesting of the user computer device and/or account, the backend system 102 may search for business information based on the identified business contact, supplying the application with pertinent updated information. In various embodiments, if the backend system 102 cannot confirm the identified business contact, the contact may be discarded or indicated as a potential business of interest needing clarification from the user. And more generally, in various embodiments, various indicia of interest may be captured, searched, correlated to logged business information, verified, updated, and/or used to gather additional related business-specific information by the application and/or the backend system 102.

In some embodiments, the personalized collection utility may include features for automatically identifying potential businesses of interest to a specific user based at least in part on user interactions with businesses, as indicated by block 512. Some embodiments may provide for options for user initiation of gathering indicia based on user interactions with businesses; some embodiments may perform the process automatically. Some embodiments may identify businesses of potential interest based on applications installed on the user computing device, such as mobile applications that are associated with particular businesses and/or business types. Some embodiments may identify businesses of potential interest based on phone call and/or messaging history information retained on the user computing device and/or available from other data sources. Some embodiments may identify businesses of potential interest based on email contact with businesses and/or business representatives. Some embodiments may identify businesses of potential interest based on calendar items related to appointments with businesses (such as hair appointments, nail appointments, dental appointments, etc.).

Some embodiments may identify businesses of potential interest based on user indications of preference (such as positive rating business, an indication of liking the business, friending or otherwise linking to a business, sharing business information with others, etc.) that the user has made via webpages and/or social media. Such indications of reference may be garnered from information associated with application on the user's computing device and/or via other data sources 110. The personalized collection utility may include features for automatically identifying potential businesses of interest to a specific user based at least in part on one or more other accounts of the user. The user's orchestration account could be linked (e.g., via API) to one or more other accounts of the user, including an account associated with online social/business networking services (which may include microblogging/short messaging services), an email account, and/or any other suitable data source 110. In some cases, the user may be prompted to login to the user's other account(s) to allow for the harvesting. In some cases, previously provided authentication information stored by the system 102 may be used so that logging in is not necessary to enable the harvest. Businesses of interest could be identified by approval/disapproval indicators, which may be in form of likes, dislikes, thumbs-up, thumbs-down, star-scale ratings, number-scale ratings, fan indications, affinity group association, messages to businesses, and/or the like. The approval/disapproval indicators could be those associated with the user's profile and/or profiles of friends/associates/connections of the user.

In some embodiments, the gathering of indicia of interest may support the generation of user profiles, and could be used to refine user profiles. In some embodiments, user profiles may be transferred from the application to the information handling system 102. In other embodiments, only information related to the profiles may be transferred to the backend system 102. The information handling system 102 may have profiles for businesses. As indicated by block 514, one or more collections may be created based on the gathered indicia of interest. As indicated by block 516, the gathered indicia of interest may be correlated to interest categories/collections. In some embodiments, the business profiles may include or be linked to one or more taxonomies that map particular businesses/business categories, particular interests/interest categories and/or particular questions for presentation to users.

As indicated by block 518, options for customization of collections may be presented to the user. As indicated by block 520, one or more collections-specific that questions may be presented to the user for identification of collection-specific businesses of interest. User-selectable options corresponding to interest categories may be presented for user selection. For example, options corresponding to categories such as my kids, my home, my pets, etc. may be presented to the user. The user-selectable options may allow the user to drill down into particular interest categories. For example, once a user taps into an individual collection, one or more questions may be presented to the user relating to the individual collection to help user set up that collection. Referring to FIG. 8B, for example, say a user taps the individual collection 828 relates to the user's category of “my home.” The user may be presented with a collection-specific graphical user interface 842, as illustrated by FIG. 8C, which shows a screenshot, which may be a partial screenshot for a personalized collection utility that may be used in implementations of certain embodiments of the present disclosure.

As indicated by 844, one potential question presented the user could be “Who's your plumber?” The question could be presented with options 848 for a number of actual plumber names, plumber business names, and/or other plumber listings for the user to select. The options 848 presented with the question could be identified based on gathered indicia of businesses of interest to the user and/or options near the location of the user, such as the nearest three or so plumbers. Though not depicted, the nearby options could be indicated on a map presented to the user with the interface 842. A text entry field 844 could allow the user to enter an indication of a plumber in response to the question. Along with such questions, a user-selectable option to skip 846 a given question or a series of questions may be presented. Referring again to FIG. 5, one or more businesses of interest may be associated with one or more collections based on user responses to the collection specific questions, as indicated by block 522.

In some embodiments, information harvested regarding a user may be used to infer potential businesses of interest to the user, as indicated by block 524. And such potential businesses of interest may be suggested to the user, as indicated by block 526. For example, if interest data indicates that a user has a pet, local businesses related to pets and/or that otherwise would only be of interest if one has a pet could be identified/suggested as potential businesses of interest. Similarly, if interest data indicates that a user is a parent, businesses that would only be of interest to parents could be identified/suggested as potential businesses of interest. As indicated by block 528, business information corresponding to businesses/potential businesses of interest may be organized into collections as discussed herein.

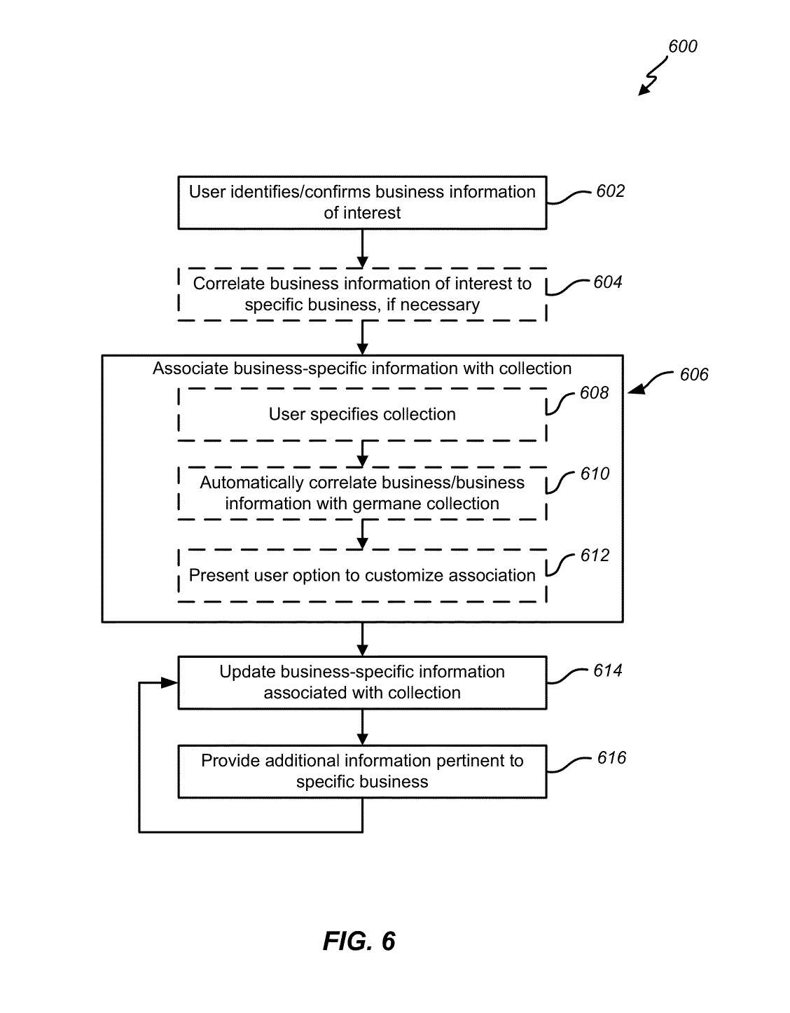

FIG. 6 is a block diagram that illustrates an example method 600 of certain aspects of a personalized business information orchestration, in accordance with certain embodiments of the present disclosure. According to certain embodiments, the method 600 may begin as indicated by block 602. Teachings of the present disclosure may be implemented in a variety of configurations. As such, the order of the steps comprising the method 600 may be shuffled in any suitable manner and may depend on the implementation chosen. Moreover, while the following steps may be separated for the sake of description, it should be understood that certain steps may be performed simultaneously or substantially simultaneously.

As indicated by block 602, an end-user may identify/confirm business information of interest. In some cases, a user may be performing a search with the application. FIG. 8D illustrates a graphical user interface 862 for searching for business information, in accordance with certain embodiments of the present disclosure. FIG. 8D shows a screenshot, which may be a partial screenshot, of an interface that may be displayed via a mobile application. In some embodiments, a webpage could implement a same or similar interface. Responsive to a search request by an end user, a set of businesses may be selected by the system 102 as corresponding to the user's search criteria, including location. The set of businesses may be compiled and presented to the consumer with as search results 864. Along with each search result 864, a user-selectable option 866 may be presented to the user so that upon user selection, e.g., a single click, a particular business may be added to the user's collections. Thus, in the example case, a specific business may already be identified by the system 102 prior to being presented to the user. In some cases, however, a specific business may need to be confirmed by the user, for example, when a suggestion has been identified based on gathered indicia of interest, and a potential business of interest is presented to the user.

As indicated by block 604, in some embodiments, the business information of interest may be correlated to a specific business if necessary. For example, when the business information of interest is not specific, is ambiguous, and/or corresponds to multiple businesses, a specific business may need to be identified based on the business information. The business information of interest could include one or more of gathered indicia of interest, responses to questions presented to the user, and/or interest categories.

As indicated by block 606, business-specific information may be associated with a particular collection. In some embodiments, the association may be according to a collection specified by the user, as indicated by block 608. In some embodiments, a user-selectable option may be presented to the user upon identification of a business of interest. For example, after a user selects an option such as option 866, a prompt could be presented to the user to indicate to which of the user's collections the particular business should be linked. In some embodiments, a user-selectable option could be presented for the particular business to be automatically correlated and linked with the appropriate collection. In some embodiments, the automatic correlation and linking of the particular business with the appropriate collection could be by default such that the user need not be prompted. Accordingly, as indicated by block 610, the business identifier or other business-specific information may be automatically correlated with a germane collection. In some embodiments, the user may be notified of the automatic correlation, and, as indicated by block 612, a user-selectable option may be presented to customize the association with the particular collection, in some embodiments.

As indicated by block 614, additional information pertinent to the specific business may be linked to the collection for presentation to the user. FIG. 8E illustrates a graphical user interface 882 for specific business information saved or savable in a collection, in accordance with certain embodiments of the present disclosure. FIG. 8E shows a screenshot, which may be a partial screenshot, of an interface that may be displayed via a mobile application. Business listing information 886 may be linked to the collection. The business listing information 886 may include address information, directions, ratings information, map information, business details, user reviews, coupons, etc. An indicator 884 may indicate that the specific business is saved in a collection or could be a selectable option to add the listing information for the specific business in a collection.

Referring again to FIG. 6, as indicated by block 616, business-specific information associated with a collection may be updated based on information from the information handling system 102. Business listing information associated with a collection may be automatically updated by the information handling system 102 such that, when listing information is retrieved from a collection, the listing information may be updated information. Thus, a collection allows for the maintenance of listing information of interest to provide a user with the most up-to-date listing information for the businesses that matter to the user. And, thus, if a provider associated with a collection has moved or changed phone numbers, the user will not be left with obsolete information (as the user would otherwise be if such information was recorded into an address book) because the change may be captured so that the collection would be automatically updated with the new information.

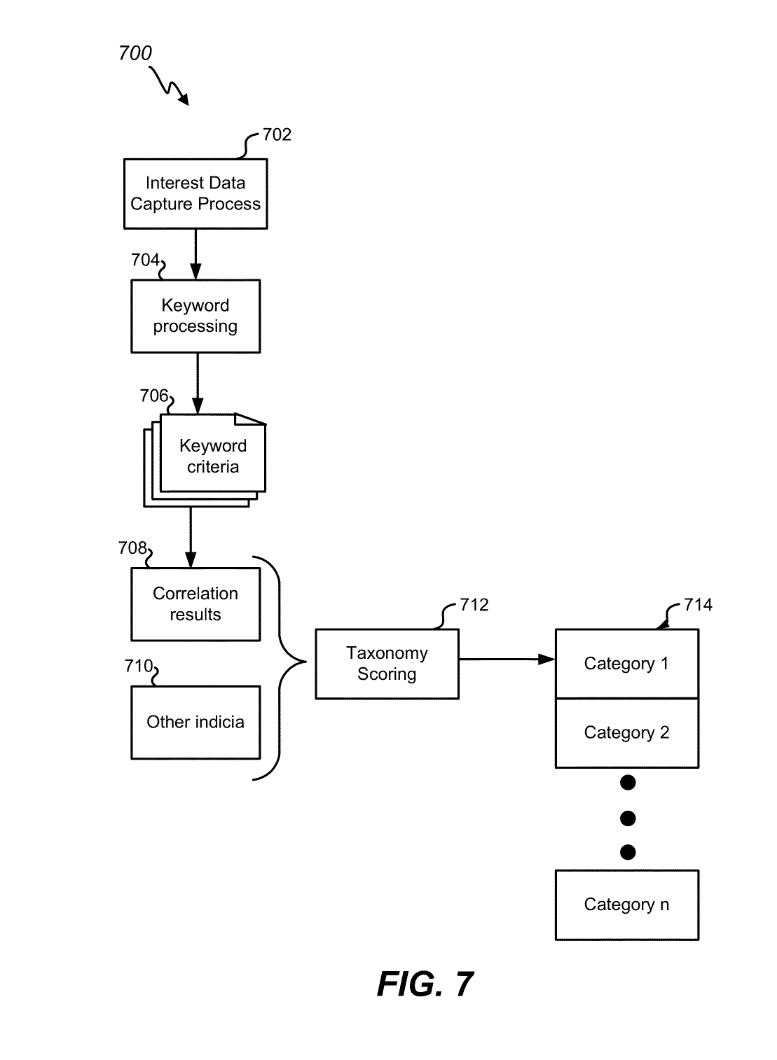

FIG. 7 depicts a functional block diagram of certain aspects of personalized business information orchestration 700, in accordance with certain embodiments of the present disclosure. Various embodiments may employ any one or combination of various methods of correlation of interest data, interest categories, and businesses.

Interest data may include any suitable information that may be captured to indicate, infer, and/or determine interest categories and/or businesses of interest. As discussed herein, certain embodiments may use a client application 351 installed on the user's computing device to facilitate data capture. In some embodiments, the client application 351 may qualify captured data in part or in whole and/or send captured data to the information handling system 102 for qualification.

Having interest data, the information handling system 102 and/or the application 351 may implement a qualification process. Some embodiments may qualify an interest according to a graduated scale. Any suitable scale may be used in various embodiments. In some embodiments, a scale could entail a categorization scheme 714, with any suitable categories. In some embodiments, a taxonomy scoring system 712 could be correlated to the category scheme, such that certain scores may correspond to certain categories so that, based on a given set of interest data, a high correlation score to a particular category may indicate the category is more appropriate. Some embodiments may score with a numerical expression. Accordingly, a taxonomy score may indicate which categories are more/most likely to be appropriate for a user, thus providing a quantitative estimate of a user interest. By way of example without limitation, a scale could include a range of scores from 0 to 90, or from 0 to 1,000, with the high end of the scale indicating greater probability. Some embodiments may use methods of statistical analysis to derive a score. Various embodiments may determine a score based on any one or more suitable quantifiers.

Some embodiments may employ a decision tree, checklist, workflow, and/or the like to capture various aspects of interest data and assess those aspects to infer interest qualification. Such a decision tree, checklist, and/or workflow may incorporate any one or combination of the depicted aspects and/or similar aspects in any desired order, according to various embodiments. Interest data can be consolidated and processed to yield a taxonomy score 712.

Certain embodiments may provide for keyword processing 704 of gathered interest data, such as any data related to indicia of interest discussed herein. In some embodiments, an impression engine, which could be included in the engine(s) 122, could perform keyword identification. The call impression engine could be configured to recognize evidence of interest potential. Taxonomy scores 712 may be based at least in part on keywords gathered.

The impression engine may identify keywords as distinctive markings and could compile the keywords for the purposes of characterization from the perspective of interest potential. The keywords could be correlated with keyword criteria 708 to characterize the data from the perspective of interest potential and to generate correlation results 708 that can be taken into account with scoring 712. In some embodiments, the correlation results 708 can be taken into account in conjunction with other indicia 710, which could correspond to any one or combination of the other indicia of interest potential discussed herein such as location information and/or the like. As discussed herein, various embodiments may employ any one or combination of methods of capturing location information, including but not limited to, gathering location information via any one or combination of the user's computing device, such as the device GPS capabilities, access points, third parties, receiving explicit location information with one or more search requests, inferring location information from one or more search requests, and/or the like.

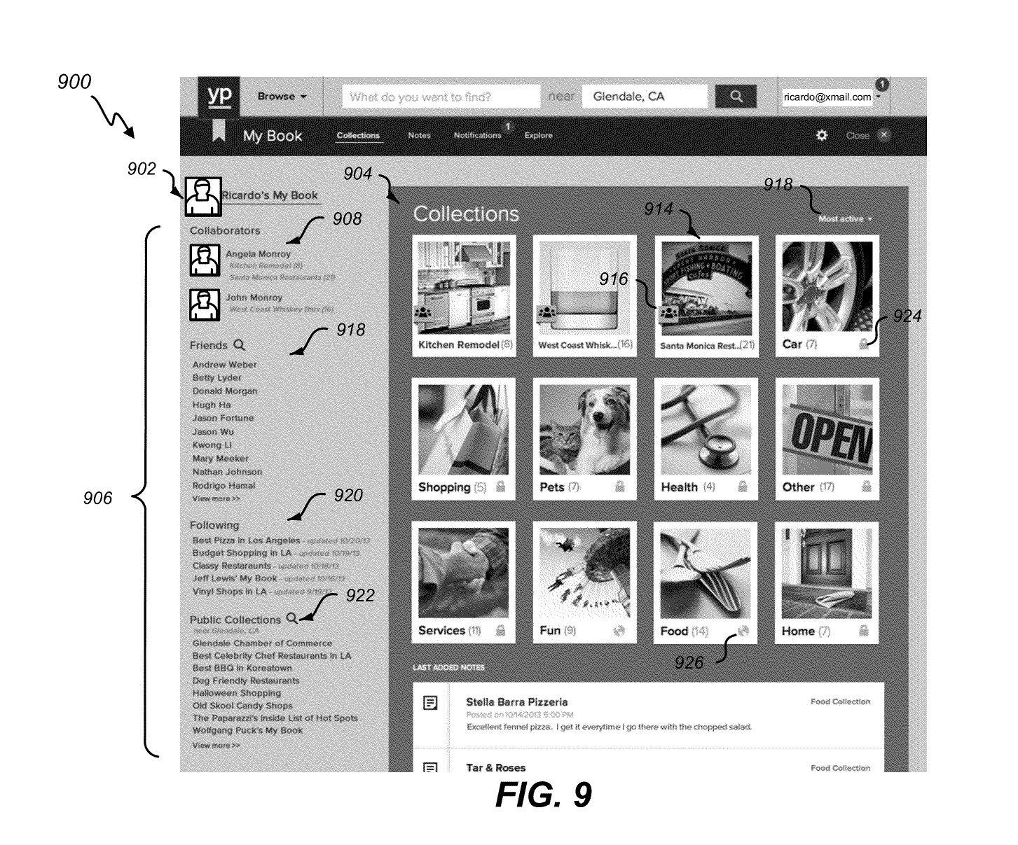

FIG. 9 is a screenshot illustrating an example end-user interface 900, in accordance with certain embodiments of the present disclosure. FIG. 9 shows a screenshot, which may be a partial screenshot, of the end-user interface 900 that may be displayed via any suitable end-user interface 105, which may correspond to a webpage or mobile application in various embodiments. The end-user interface 900 may correspond to an end-user's personal account that would be accessible to the end-user after login and authentication.

The end-user interface 900 may present user identification information 902 that may retain in the one or more repositories 128. In various embodiments, user identification information 902 may include, for example, the user's name/alias, one or more images associated with the user (such as, images uploaded by the user, more or less generic images selected by default, and/or images pulled from other data sources, such as the user's linked online social media account(s)), and/or the like.

The end-user interface 900 may be presented responsive to a request for user's personalized business information transmitted from the end-user computing device, such as a login request. The system 102 may access the user's personalized business information retained in the one or more repositories 128. In some embodiments, certain personalized business information may be retained locally on the end-user computing, and the local information may be synchronized/updated based on the information retained in the one or more repositories 128. In other embodiments, personalized business information may be freshly transmitted, in whole or in part, from the system 102 to the end-user computing device.

The user's personalized business information may be provided in according with the user's curation information. The personalized curation information may include geo-relevant graph information specific to the user. The geo-relevant graph information may include collection information that specifies one or more collection characteristics. The collection characteristics may include any suitable parameters defining aspects of the user's collections, including one or more of collection themes, associated business categories, information about location(s) of interest to the user, businesses windows mapped to the collections, arrangement information specifying a visual arrangement of collections to presented to user, custom content added and/or modified by the user and/or other users (such as notes, images, graphical customizations, editorial customizations, etc.), privacy attributes, and/or any other collection characteristics described herein.

The geo-relevant graph information may include window information that specifies one or more window characteristics. The window characteristics may include any suitable parameters defining aspects of the windowed information provided to the user, including one or more of specific businesses mapped to a given window, geo-specific criteria for the specific businesses, custom content added and/or modified by the user and/or other users (such as notes, images, graphical customizations, editorial customizations, etc.), privacy attributes, and/or any other window characteristics described herein.

In some embodiments, the system 102 may access a set of business information retained in the one or more repositories 128, the set of business information being related to businesses specified by the geo-relevant graph information. The system 102 may window the set of business information to at least partially form one or more windowed sets of information. The windowing could include one or more of identifying selecting, processing, compiling, arranging, and/or providing any pertinent business information for a particular business of interest described herein.

For example, in various embodiments, the windowing could include using geo-specific criteria to furnish information for a particular business location (e.g., one out of multiple location options, say, for a business chain or other business that has multiple sites), a particular provider and/or contact (e.g., one out of multiple provider and/or contact options for a particular business), and/or the like. The windowing could include selecting only particular information items that pertain to a particular window. In some cases, a user could modify the type of content desired for a particular business, and particular information items could be furnished accordingly. The windowing could include checking the set of business information for updated information (such as changes in contact information, location information, review information, and/or any other pertinent information).

In some embodiments, the windowing could include gathering user-generated content pertaining to a particular business, discussed further herein. In some cases, user-generated content was previously provided by the end user and retained by the system 102. In some cases, user-generated content was previously gathered, pushed, and/or pulled from data sources 110 and retained by the system 102. In some cases, user-generated content is actively gathered, pushed, and/or pulled from data sources 110 on an as-needed basis to freshly provide the content with the windowed set of information and/or to update/check content previously retained and that is to be provided with the windowed set of information.

In some embodiments, windowed sets of information may be formed and retained by the system 102 in anticipation of a request to provide the information to the user. In some embodiments, windowed sets of information may be formed responsive to a request. In some embodiments, previously formed windowed sets of information may be updated responsive to a request. In various embodiments, window information components may be compiled prior to transmission to an end-user computing device and/or may be transmitted separately.

In the example depicted, the end-user interface 900 may present the user's current collections 904, the curation of which is facilitated by the platform. The user's current collections 904 may be indicated in any suitable manner, including with images, color coding, alphanumeric indicia, and/or the like. A sorting feature 918 may allow for presentation of one or more user-selectable options to sort the collections 904 in any suitable manner, including according to activity (e.g., activity by the user, a collaborator, a business, business information updating via the system 102, review activity, activity by other users registered with the orchestration service and/or other users interacting about the particular businesses via online social media services, and/or the like), latest updates, latest additions of businesses to a collection, alphabetically according to collection name, number of businesses associated with a collection, collaborative/non-collaborative characteristic, public/non-public characteristic, and/or the like.

In some embodiments, like the example depicted, numbers of businesses associated with each collection may be indicated. For example, twenty-one businesses are indicated as associated with the collaborative collection directed to the Santa Monica Restaurant theme, in the collaborator section 908 and in the collection section 904 with indication of the Santa Monica Restaurant collection 914. And, generally, with presentation of collections 904, whether collaborative or not, numbers of businesses associated with each collection 904 may be indicated as in the depicted example (e.g., the Car collection is textually indicated as having seven associated businesses) or in any other suitable manner.

One or more user-selectable options may be available to the user to designate whether a collection is public or private. A private designation could be a default in some embodiments. If a collection is designated as public, the collection could be viewable/searchable to other users. In some embodiments, collections may be graphically distinguished in any suitable manner based on being public or private. The example depicted portrays illustrative graphical private collection indicators 924 and public collection indicators 926. A collection could also be designate as viewable/searchable to a select group of other users. For example, the select group could include other users individually selected by the user, other users who are also friends/associates via an online social/business networking service, other users who associated with a certain affinity group, and/or the like.

The end-user interface 900 may include one or more social panes 906. The one or more social panes 906 could include a collaborator section 908 for embodiments that provide the option for the user to allow one or more collaborators to have access to one or more collections. For example, a husband and wife may both curate a Kitchen Remodel collection, like the depicted example, in view of their kitchen remodeling project. As another example, a user may collaborate with another in planning a trip, say a tour of the West Coast, visiting whiskey bars along the way. To that end, the tourists could curate a West Coast Whiskey Bars collection, like the depicted example. Accordingly, the collaborator section 908 could include information about one or more collaborators that have access to one or more collections of the user.

The end-user interface 900 may be configured to indicate, not only collaborators, but also the particular collaborative collections. In the example depicted, Angela M. is indicated in the collaborator section 908 as a collaborator with Ricardo on a kitchen remodel collection and a Santa Monica Restaurant collection. Collaborative collections may be graphically distinguished from non-collaborative collections. For example, a graphical indicator 916 corresponding to the Santa Monica Restaurant collection may indicate the collaborative nature of the collection. However, collections may be distinguished in any suitable manner, including with images, color coding, alphanumeric indicia, and/or the like.

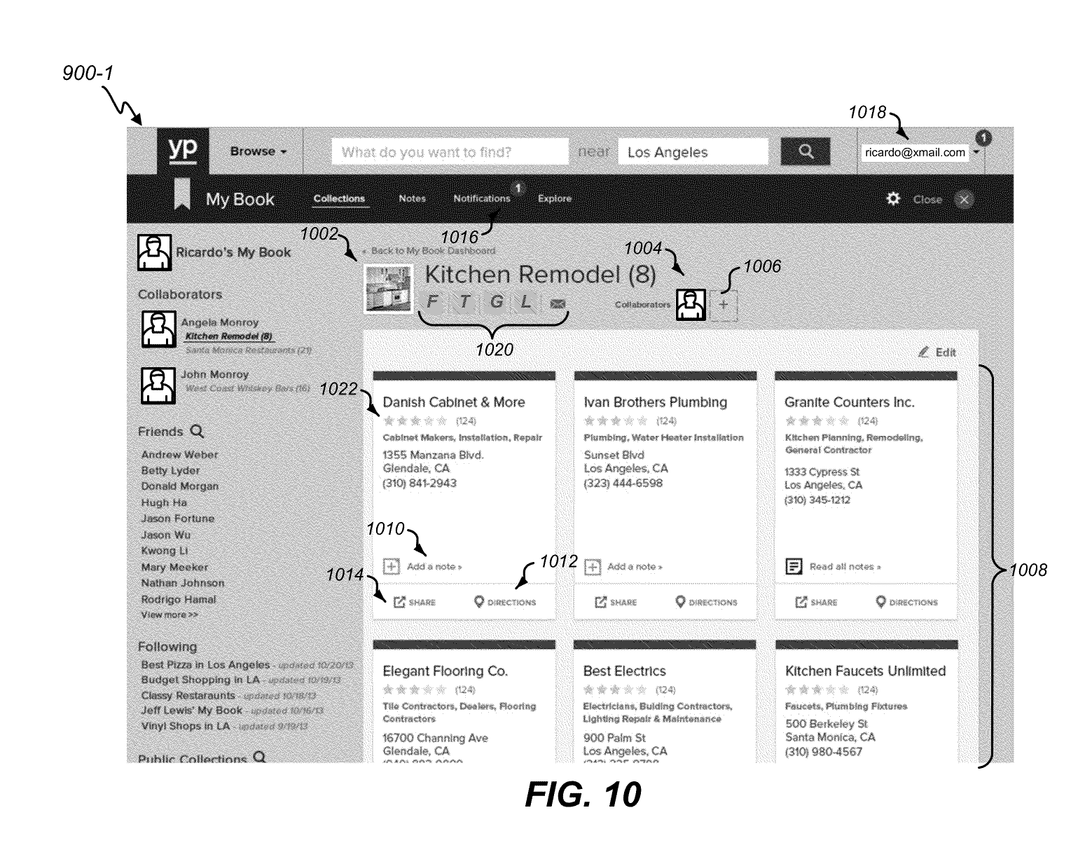

One or more user-selectable options may be provided to navigate to a collaborative or non-collaborative collection. For example, the user may tap or click into one of the collaborative collections 904 that is designated as being collaborative. FIG. 10 shows a screenshot, which may be a partial screenshot, of the end-user interface 900-1 that may be displayed after navigating/drilling down into a collaborative collection 1002. The example depicts a Kitchen Remodel collection 1002 relating to a remodeling project. The collection 1002 may include one or more curated information windows 1008, each corresponding to a business.

Each information window 1008 may present any suitable listing information for the respective business. In some embodiments, the listing information may be retained on the backend system 102 and provided to the user portal on demand. In some embodiments, the listing information may be retained on the user device 105 and updated by the backend system 102 on any suitable basis, including, for example, based on one or more of user login, user access of particular collections, launch of the application, a batch process, a real-time update when new information is available, and/or the like. In some embodiments, an information window 1008 may include advertisements from a business, images associated with a business, options for video/audio from a business for presentation to the user, a video/audio/textual chat option to connect with a business, a select-to-call option to connect with a business, and/or the like. An information window 1008 may include a directions feature 1012 configured to provide directions and/or mapping information consequent to user selection. The information may be provided in conjunction with a mapping application, resident on the device 105 and/or network-facilitated.

An information window 1008 may include a notes feature 1010 configured to allow the user to make and retain notes related to the provider, such as notes on the providers, indicia of whether the user likes particular providers or not, which providers have been contacted, information obtained from providers, which providers have been selected, etc. Any suitable content could be added in accordance with various embodiments. A user could add photos, for example. Say, a user has a photo of a desired kitchen design that the user wants to mimic for the user's kitchen remodel; the user could upload the photo to a kitchen remodel collection. In some embodiments, a user could import a photo from another account of the user, say a photo-sharing/repository account, an online networking services account, etc. The user could link to the other account as described herein, and a data collection utility provided by the orchestration account may be configured to port the photo(s) to the user's collection/window.

As another example, photos of one or more of a service need, a completed service, a service in progress, receipt(s), warranties, invoices, and/or the like could be uploaded to the orchestration account. Each photo may be time-stamped by the system 102 and retained in the one or more repositories 128 for later access and retrieval by the user. Accordingly, the platform may provide a way to have a filing system directed to services—a record system for the user. As described herein, a vendor could be a collaborator or could be otherwise enabled to view certain collections/windows of the user. In this manner, certain embodiments may provide an additional means to facilitate ongoing engagement with local vendors.

An information window 1008 may include a share feature 1014 configured to share an information window 1008 with others in one or more ways. For example, the share feature 1014 may include one or more user-selectable options to propagate the information window 1008 to another collection in some embodiments. Say, for example, that the user decides a particular business is appropriate for another collection of the user, the user can add the corresponding information window 1008 to the other collection via the share feature 1014.

As another example, the share feature 1014 may include one or more user-selectable options to share the information window 1008 with another user of the online orchestration service in some embodiments. In some embodiments, entire collections can be shared. The end-user interface 900-1 may include one or more collection share options 1020 configured to allow sharing of collection information in any suitable manner.

A window and/or collection could be shared with another user of the online orchestration service, for example, via a notification to an account associated with another user. Responsive to a share selection, the platform may send a notification to an account associated with another user. The notification could be provided via the other user's account. By way of example, the end-user interface 900-1 may include notification features 1016 that allow a user to be apprised of new notifications received as directed to the user, and allow the user to view the notification(s) upon user selection of one or more notification options. Thus, in the example depicted, the user, Ricardo, could receive a notification 1016, which could be a result of another user sharing an information window 1008 and/or collection 1002.

In various embodiments, the shared information could be at least partially viewed and/or incorporated into user's account with viewing of the notification 1016, with viewing a message corresponding to the notification 1016, and/or with selection of one or more user-selectable options provided consequent to the notification 1016. The presentation of shared information could be by way of summary information that summarizes and/or characterizes information from/relating to the shared collection. For example, summary information about the shared information could be generated and included for viewing with viewing of the notification 1016 and/or a message corresponding to the notification 1016. In some embodiments, the shared information could be viewed, at least in part, with selection of one or more user-selectable options provided with the notification 1016 and/or a message corresponding to the notification 1016. In some embodiments, one or more user-selectable options may be provided for incorporating the corresponding collection/information window into a collection of the user.

The share feature 1014, 1020 may include one or more user-selectable options to share the information window 1008 and/or collection 1002 with others via any suitable means of notification. For example, text messages, voice notifications, push notifications, e-mails, social/business networking services account postings/messages, alerts with the application, and/or other any suitable means could be employed to allow for the presentation of collection/window information. In some embodiments, the user's orchestration account could be linked (e.g., via API) to one or more other accounts of the user, say, an email account, for example. The end-user interface 900-1 may include linked account features 1018 that may allow for notifications of any communications received via the other account and/or may provide one or more user-selectable options to launch and/or otherwise access the other account.

The user's orchestration account could link to any suitable account of the user, including an account associated with online social/business networking services and/or any other suitable data source 100. And, thus, a posting about the business could be made in association with the user's account and/or another's account responsive to the user selection of the share option. In some cases, the user may be prompted to login to the user's social/business networking media account to make the posting. In some cases, previously provided authentication information stored by the system 102 may be used so that logging in is not necessary to make the posting in the other account. The share feature 1014, 1020 may be configured to facilitate the setup of the information sharing, whether it be a networking services account posting, an email, a text message, or otherwise, and present the communication setup for previewing and dispatch by the user. A link or other user-selectable option could be shared to allow for the viewing/incorporation of further collection information. In some embodiments, users who are not yet registered with the service could be invited to do so in conjunction with a collection sharing communication.

In some embodiments, a snapshot of a collection or a single window could be shared. The snapshot could take any suitable form, include an image, a text file, and/or the like. A share feature 1014, 1020 could present an option to send a snapshot, and, consequent to user selection, could convert a collection/window to a shapshot form and proceed with communication in a manner discussed above.

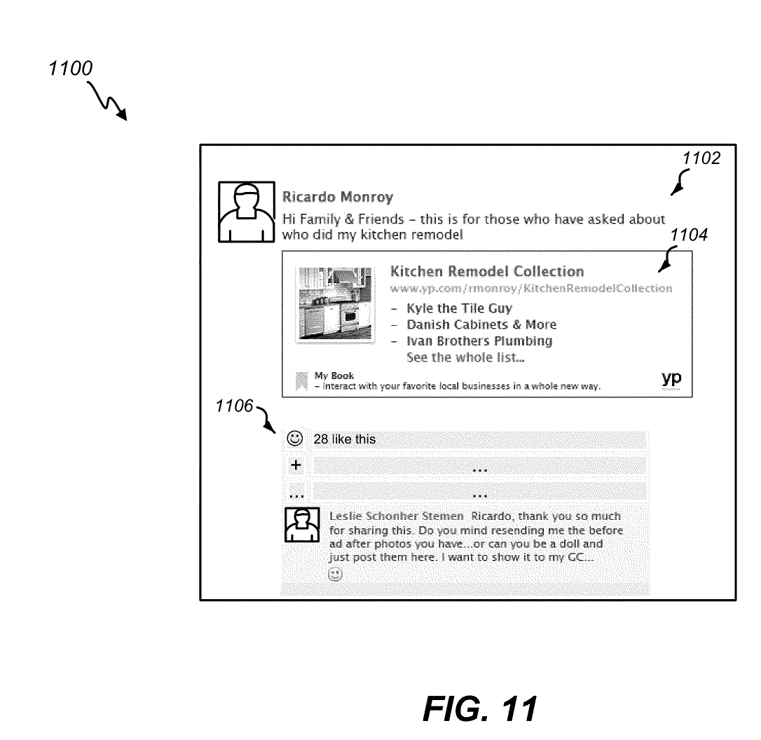

FIG. 11 shows an example 1100 of sharing collection information via social/business networking services account postings, in accordance with certain embodiments. Say, for example, the user, Ricardo, is asked about who did the work on his kitchen remodel. The user can share information about his Kitchen Remodel Collection via a posting 1102 to his social media account. The posting 1102 may include summary information 1104 about the collection. The posting 1102 may include one or more user-selectable options to view more collection information, to view collection information via the online orchestration service, to login/register with the orchestration service, and/or the like.

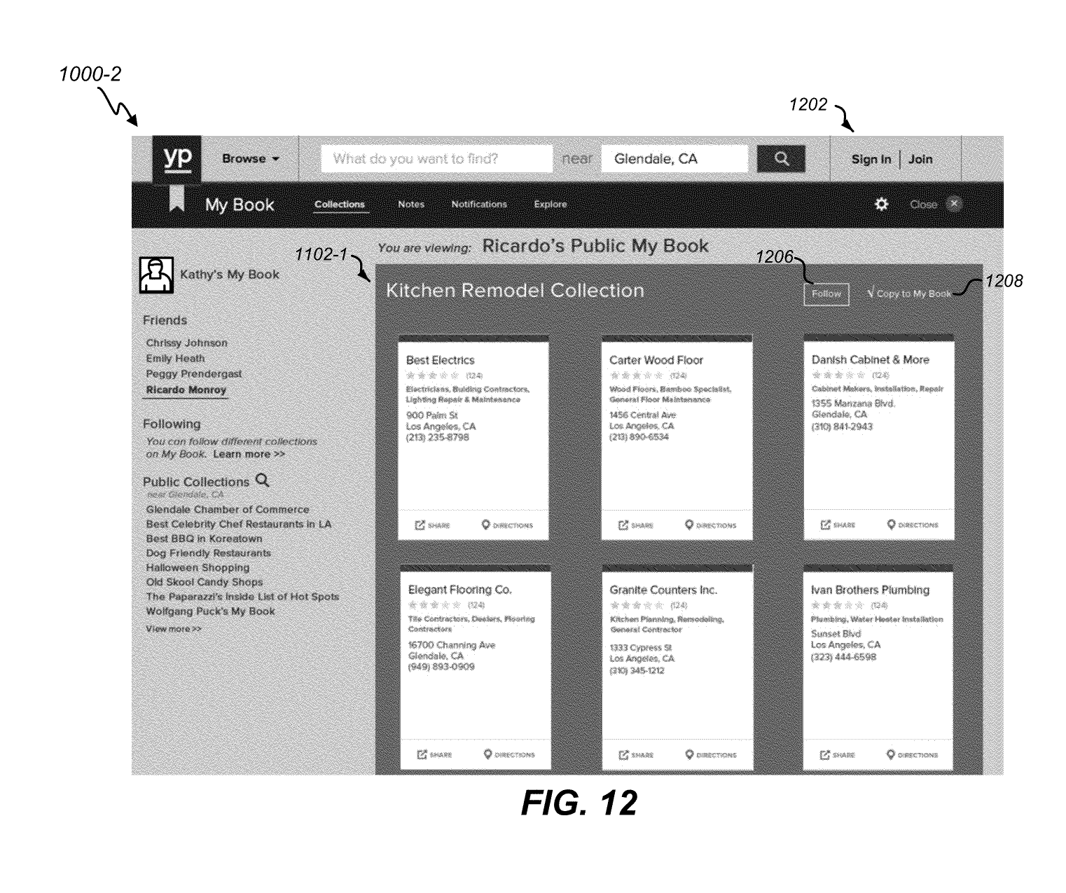

For example, one or more user-selectable options may be provided to navigate to a public profile accessible via the orchestration platform. FIG. 12 shows a screenshot, which may be a partial screenshot, of a public profile 900-2 that may be displayed after selection of a link made available with posting 1102. The example depicts Ricardo's public Kitchen Remodel Collection 1002-1. The collection 1002-1, having been designated as public, could be a landing page viewable, for example, as a result of a user selection of a link from a posting 1102.

In some embodiments, one or more user-selectable options may be presented depending on the viewer. For example, login/registration options 1204 may be provided. For a registered user, a follow option 1206 may be provided to enable the user to follow Ricardo's collection. After the user opts to follow the collection, update notifications may be sent to the user based on subsequent actions taken with respect to the collection, such as collection curation, annotation, augmentation, and/or any modification of interest taken.

For a registered user, a copy option 1208 may be provided to enable the user to copy the collection 1002-1 to the user's set of collections. Once copied over to the user's collection set, the copy could become the user's collection. The user may then use and modify the collection as desired.

Referring again to FIG. 11, in some embodiments, user feedback from the social/business networking services may be captured by the system 102. For example, information about user approval/disapproval indicators 1106, which may be in form of likes, dislikes, thumbs-up, thumbs-down, star-scale ratings, number-scale ratings, and/or the like, could be captured. Captured user feedback could be processed and reflected back through the orchestration services platform. Thus, a certain collection and/or business may have accumulated user feedback from other for a and such feedback could be indicated via the user's collection(s) and/or information window(s) in any suitable manner.

Referring again to FIG. 10, the interface 900-1 may indicate user feedback data in any suitable manner. For example, an information window 1008 may include one or more user review indicators 1022. Similar review features could be provided on a collection basis, in addition or alternative to an individual business basis. The one or more user review indicators 1022 may include composite and/or segregated review information garnered from reviews via the listing service of the platform, online social/business networking service(s), the orchestration service, and/or any suitable data source(s) 100. In various embodiments, the system 102 may actively monitor, gather, push, and/or pull user feedback data from such sources in any suitable way. As a particular example of gathering user feedback on businesses, in many cases, businesses associated with the system 102 may have individual business pages setup for public viewing/interfacing via a one or more online social/business networking services and/or other data sources 100. In some cases, the system 102 may facilitate setup of such business pages for the businesses. User feedback data from such sources may be monitored, gathered, and/or pulled by the system 102.

When presented via the interface 900-1, the source of composite review information could be distinguished. For example, review information coming from the listing service could be so indicated, review information coming from social media could be so indicated, etc. Moreover, the types of review information could be differentiated. For example, say user feedback from one social media site includes feedback in the form of “like” indications; an information window 1008 could indicate the number of likes that the business received via that social media site over any time period(s) of interest (e.g., the past year, six months, month, week, day, hour, etc.). Thus, certain embodiments may provide for temporal windowing may allow a user to see businesses trending in the user's neighborhood, city, and/or other local area.

The example depicts the collection 1002 configured as having one collaborator, as indicated by 1004. A collaborator could be another user of the online orchestration service in some embodiments. In some embodiments, users who are not yet registered with the service could be invited to do so in conjunction with an invitation from a registered user to be a collaborator. One or more user-selectable options 1006 could be presented via the end-user interface 900-1 to allow the user to enlist collaborators, who may be registered users or who may not be registered. Responsive to enlist option selection, the platform may send a notification to an account associated with an invitee. In some embodiments, where an invitee is a registered user, the notification could be provided via the invitee's accounts. The end-user interface 900-1 may include notification features 1016 that allow a user to be apprised of new notifications received as directed to the user, and allow the user to view the notification(s) upon user selection of one or more notification options. Thus, in the example depicted, the user, Ricardo, could receive an invitation via a notification 1016. However, any suitable means of notification may be employed. For example, text, voice, e-mail, alerts with the application, and/or the like could be sent. In some embodiments, the user's orchestration account could be linked (e.g., via API) to another account of the user, say, an email account, for example. The end-user interface 900-1 may include linked account features 1018 that may allow for notifications of any communications (which communications are not limited to collaboration and registration invitations) received via the other account and/or may provide one or more user-selectable options to launch and/or otherwise access the other account. A notification could include a link or other communication reference referring back to the platform, prompting the invitee to respond. For example, the notification could provide a link for users to register and/or login to the platform to respond. In some embodiments, the invitee may respond via the same medium in which the notification was sent (e.g., text, voice, e-mail, etc.), and the system 102 may process the response, extracting requested information.

Some embodiments may allow the user to determine a level of access granted to a collaborator. In some embodiments, the access could be read-only access. Thus, the user could specify that one or more other users may only be allowed to view a certain collection. In addition to viewing access, the level of access could include write access. A collaborator could have editing access and/or access to add content such that the collaborator may add notes, photos, preference indicia, ratings indicia, additional business selections/information, etc. Accordingly, any changes that one collaborator makes to a collection may be reflected in the collection as viewed by one or more other collaborators.

A collaborator could be a service provider associated with one or more of the businesses designated in the collaborative collection. For example, a user might want a general contractor to be a collaborator on a project, which general contractor could be associated with a designated business or could be independent. Accordingly, such collaborators could help coordinate a project or otherwise provide input on a project. And, more generally beyond the example of a general contractor, any desired business provider could be a collaborator and be enabled to provide input.

Referring again to FIG. 9, the one or more social panes 906 could include a friends section 918 for embodiments that provide for interaction between the orchestration service and one or more online social media services (e.g., via API). A user may have the option to associate the user's orchestration account with one or more social/business networking services. One or more user-selectable options and workflows may be provided for the user to provide necessary authentication information for the user's other networking account(s) and to associate the other networking account(s). In some embodiments, the system 102 may retain the authentication information and link to the data sources 110 to coordinate interface with the other accounts, gather information from the user's particular account(s), and provide information for presentation via the end-user interface 900. Consequent to such association, the friends section 918 could identify friends and/or others that are linked to the user via social/business networking services. Additional information, such as whether certain friends/associates are logged in to the orchestration service and/or social/business networking services, could be presented via the friends section 918. Those friends/associates that have orchestration accounts could be distinguished from those that do not in any suitable manner.

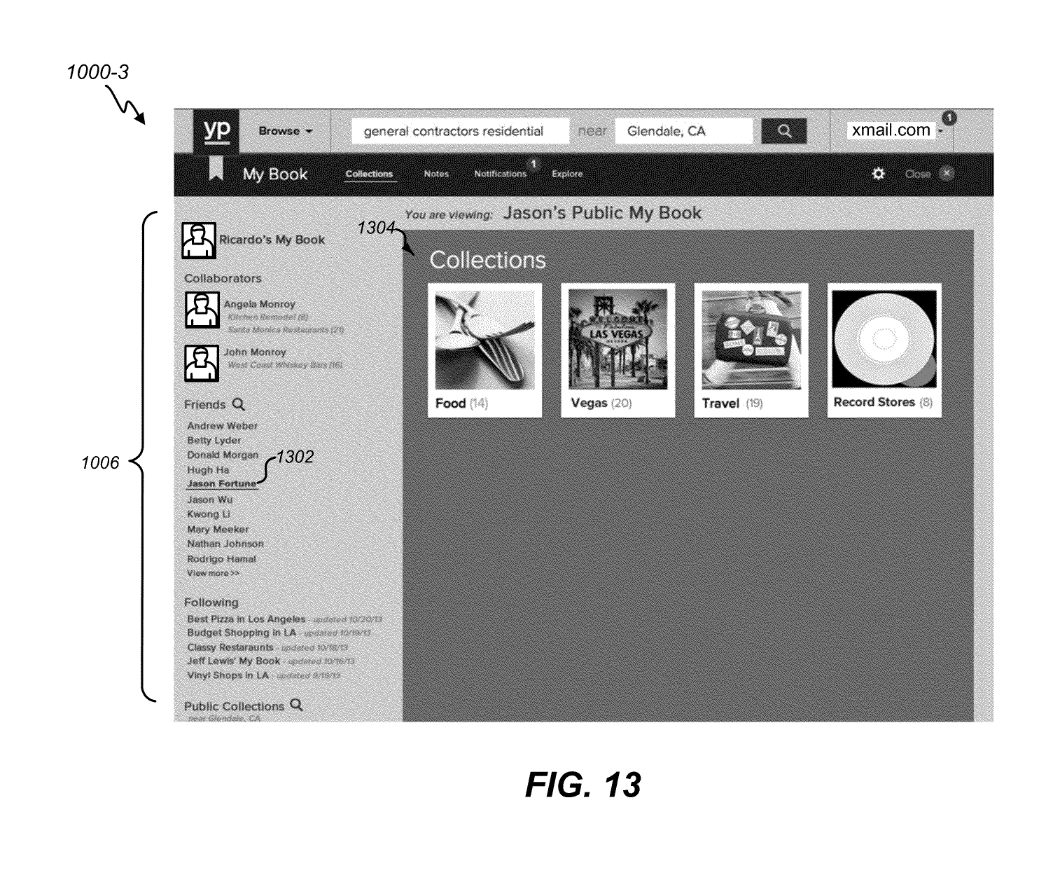

In some embodiments, one or more user-selectable options may be provided to navigate to another user's account. The friend indicators in the friends section 918 could in include such options, for example. In addition or alternative, a search interface could be provided to search for other user accounts. FIG. 13 shows a screenshot, which may be a partial screenshot, of the end-user interface 900-3 that may be displayed after navigating to another user's public collections, for example, by selecting an option 1302 from the social panes 906. The example depicts public collections 1304 of another user, Jason. Accordingly, only those collections 1304 which have been designated as public would be viewable.

Referring again to FIG. 9, the one or more social panes 906 could include a collection following section 920. The collection following section 920 may identify public collections that the user has selected to follow. Additional information, such as update information or any other suitable information pertaining to the followed public collections, could be indicated, as well. Update notifications could be general or could be specific, indicating, for example, that business information has changed (new telephone number, new reviews, new ratings, a change in ratings of the business by third party organizations, a change in business profiles/webpages, etc.)

The user may be presented with options to search 922 for public collections of others. The search could be geo-aware such that public collections associated with the user's general vicinity could be searched. The option to search another vicinity of interest to the user could also be provided so that the user may indicate a different vicinity of interest. In some embodiments, options to input a trip, by starting point, endpoint, route, and/or otherwise may be provided so that the user could search for collections relevant to the trip. For example, a user may be interested in a tour of California wineries and may so indicate in order to search for collections pertaining thereto. Public collections could be selected for presentation to the user based at least in part on one or more of business location(s) in relation to a location of interest to the user, relevance of a business to an identified interest of the user, how many users are following the collections, positively trending collections with respect to a particular time period(s) (which trending could be based on collection additions, collection followings, ratings, and/or any suitable basis), activity in the collections, ratings of the collections, and/or the like. Certain public collections could be selected for presentation to the user as suggestions, though the user may not have actively searched for the public collections. Having found a public collection of interest, one or more user-selectable options may be presented to the user to peruse, share, incorporate into the user's collection(s) (selectively or in whole), and/or follow the collection.

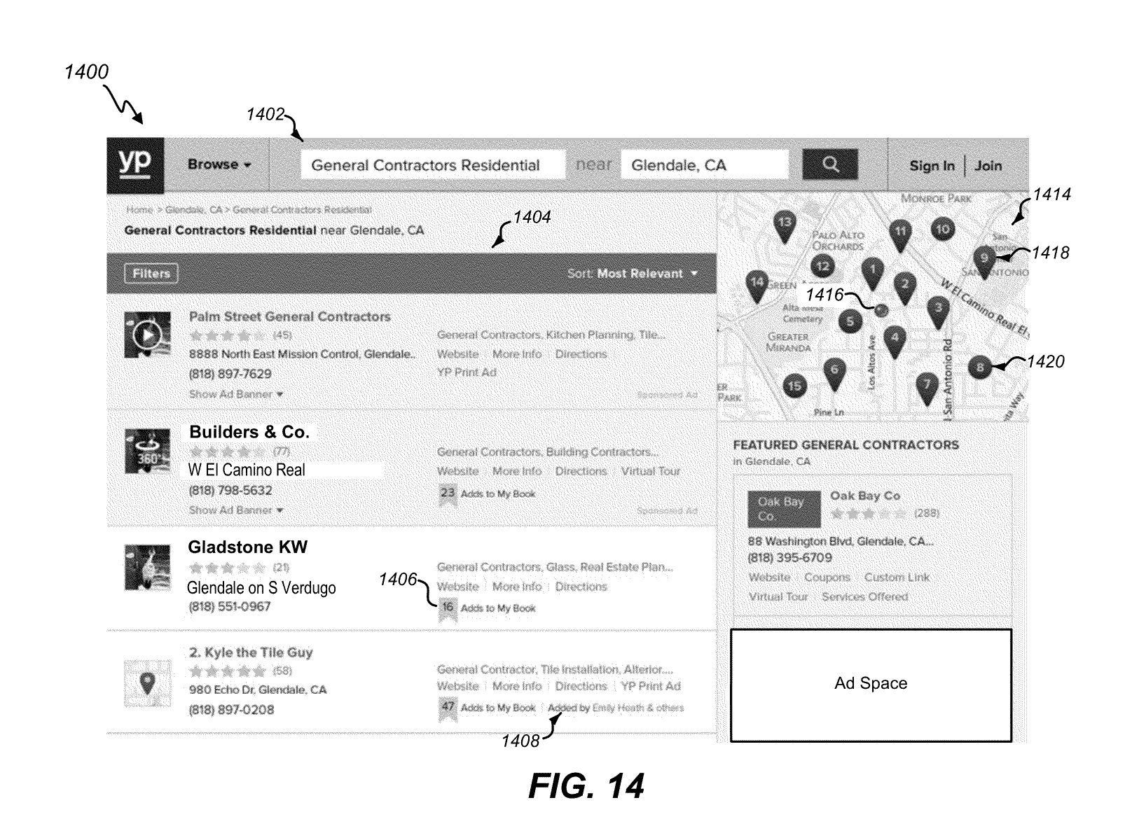

FIG. 14 shows a screenshot, which may be a partial screenshot, of a search interface 1400 that may be displayed via a mobile application, webpage, or any suitable end-user interface 105, in accordance with certain embodiments of the present disclosure. A search feature 1402 may be provided with one or more of the end-user interfaces 800, 900, and/or the like. The search feature 1402 could be made available to registered users, non-registered users, and/or non-logged-in users. The search feature 1402 may include a query field and a location field, and may be the same or similar to search interface features described herein. Responsive to a search request by an end user, a set of businesses may be selected by the system 102 as corresponding to the user's search criteria, including location. The set of businesses may be compiled and presented as search results 1404.

In some embodiments, interest data, user preferences, curation characteristics, collection characteristics, demographic characteristics, business characteristics, profile types/characteristics, and/or the like that correspond to particular end users could be characterized by the system 102 and retained as user-specific profiles associated with various criteria (e.g., keyword criteria, taxonomy criteria, categorization criteria, etc.) that allow for correlation of multiple end users based on end-user characteristics. The system 102 could anonymize any of such information and could provide anonymous depictions of user preferences and profile types to help personalize the experience for a given end user and help find businesses that other users like the given end user enjoyed. User-selectable options for user-specific profile types, criteria, and/or any suitable characterization of other users could be presented via the search interface 1400 to allow for searching. For example, a user could search for other users that have interest in pets, children, or any suitable interest category, and be presented with anonymized search results for the user to see what businesses are of interest to those other users. A user could refine a search by demographic characteristics, location characteristics, interest data, user preferences, curation characteristics, collection characteristics, business characteristics, profile types/characteristics, and/or the like. In some embodiments, the system 102 may automatically search on behalf of the user, without user selection, and present search results as suggestions to the user. The search results could anonymously indicate any suitable characterization of the other users.

In some embodiments, certain public collections could be selected for presentation to the user with the search results 1404. In some embodiments, the collection could be selected as suggestions, though the user may not have actively searched for the public collections. One or more user-selectable options may be presented to the user to peruse, share, incorporate into the user's collection(s) (selectively or in whole), and/or follow the collection.

In some embodiments, with respect to particular business listing in the search results 1404, an indicator 1406 may indicate whether a particular business listing is in a collection by other users and may further indicate a number of users who have added the particular business listing to a collection. Such information indicated by the collection addition indicators 1406 may lend a measure of credibility and trustworthiness to a business; an addition to one's collection indicates a willingness/desire to engage with a business.

Some embodiments may provide a map view 1414 of search results. The map view 1414 could indicate search results depicted in a vicinity of a reference location 1416 that corresponds to the location of interest. Collection addition indicators 1418 could be positioned on the map view 1414 to indication business locations corresponding to the search results. The collection addition indicators 1418 may each indicate a number of users who have added a particular business listing to a collection. In some embodiments, the collection addition indicators 1418 may correspond to a set of the most relevant search results, and relatively less relevant search results could be indicated by different collection addition indicators 1420. The indicators 1418 and 1420 could be graphically distinguished in any suitable manner, including with images, shape differentiation, color differentiation, alphanumeric indicia, and/or the like. One or more of the indicators 1418 and 1420 could correspond to user-selection options that allow a user to view further details consequent to selection of a particular indicator.

In some embodiments, one or more user-selectable options may be provided for refining location criteria for the collection addition indicia. For example, a user may be able to indicate a range, such as a radius of X miles from specified location of interest. In some embodiments, a user could indicate an area of interest with any suitable parameters, e.g., including one or more counties, municipalities, zip codes, distances from reference points, etc. In some embodiments, a user-selectable map interface may be presented, enabling user to define an area by selecting one or more points on the map interface. For example, predefined service areas, such as zip codes and/or the like, could be presented on the map for selection. The map interface could allow a user to define a perimeter of a service, e.g., by drawing on the map with a line drawing tool, cursor, finger/stylus contact with a touch interface, selection of perimeter boundaries such as roads, rivers, etc. Hence, collection addition indicia may be location-specific and refined to any suitable degree of granularity to provide enhanced relevance.

A user logged in to the orchestration platform could have a linked social/business networking services account. And, in some embodiments, with respect to a particular business listing in the search results 1404, an indicator 1408 may indicate whether a particular business listing has been added by others who are friends/associates/connections of the user via an online social/business networking service, other users who associated with a certain affinity group, and/or the like. Thus, certain embodiments may surface user-generated content from social graphs in order add a trust factor for consideration of particular businesses, if applicable. The network-specific addition indicators 1408 may be differentiated from more general collection addition indicators 1406 in some embodiments in order to add trustworthiness differentiation, as an addition of a business to personal collection by social media friends may be considered as an endorsement and may further allow reaching out to the others for further information if desired.

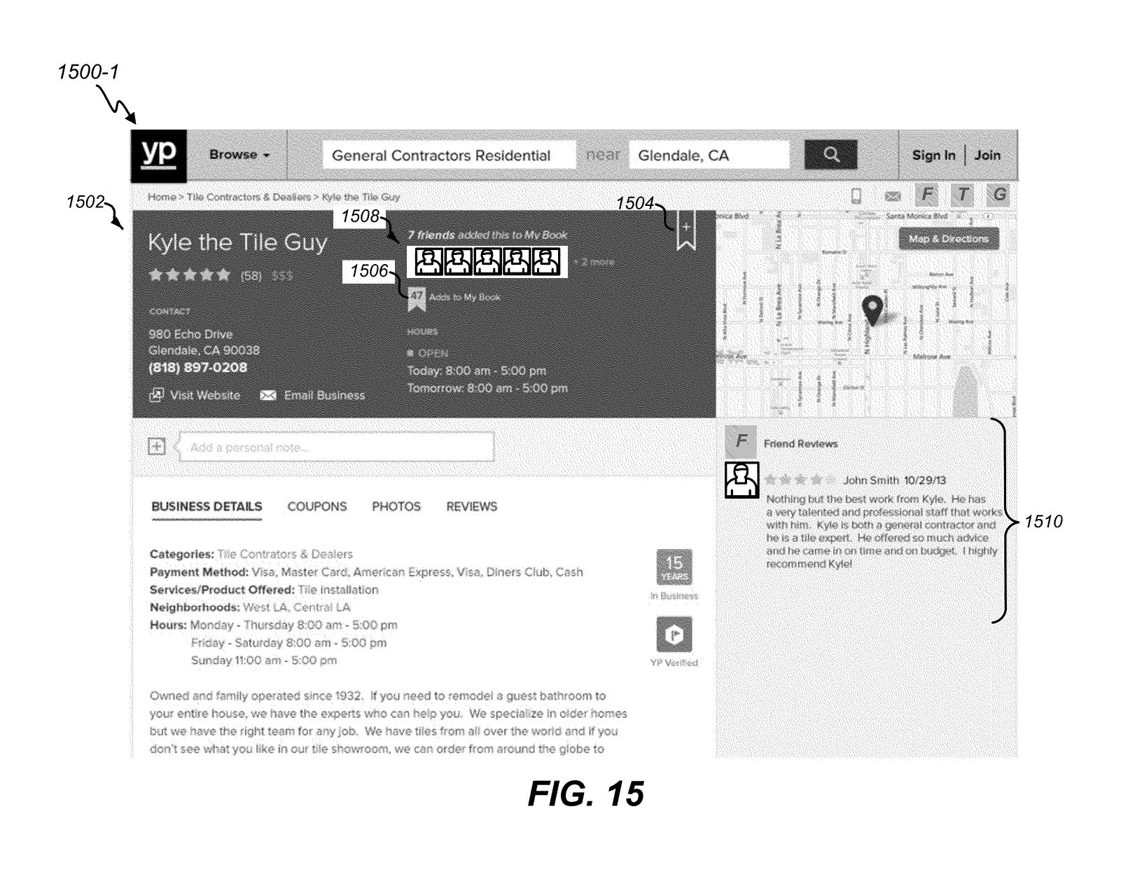

User-selectable options may be presented to the user with search results to allow a drill-down to more specific information for a particular business. FIG. 15 shows a screenshot, which may be a partial screenshot, of a search interface 1400-1 with business-specific information 1502 that may be displayed responsive to user selection, in accordance with certain embodiments of the present disclosure. With respect to a particular business, the business-specific information 1502 may include any one or combination of information items and/or features described herein. A user-selectable option 1504 may be presented to the user so that upon user selection, e.g., a single click, a particular business may be added to the user's collections. A collection addition indicator 1506 may indicate whether a particular business listing is in a collection by other users and may further indicate a number of users who have added the particular business listing to a collection. A network-specific indicator 1508 may indicate whether a particular business listing has been added by others who are friends/associates of the user via an online social/business networking service, other users who associated with a certain affinity group, and/or the like. In some embodiments, the network-specific indicator 1508 may include images of the friends/associates scraped from the social/business networking service.

The business-specific information 1502 may include a friends/associates review window 1510 that surfaces review content by the user's friends/associates gathered from one or more online social/business networking services. The system 102 may actively monitor, gather, push, and/or pull review content from one or more online social/business networking services in any suitable way. In some embodiments, like the example depicted, the review window 1510 may surface individual review content, that is, content from an individual friend/associate of the user. The review content may include any one or combination of reviewer identification information, ratings, review comments, preference indicia, date information, and/or the like. The review content may be gathered from business pages associated with the one or more online social/business networking services in some cases. In some embodiments, review content may be gathered from business websites, with the reviewers being correlated to the user as being related via the online social/business networking services.

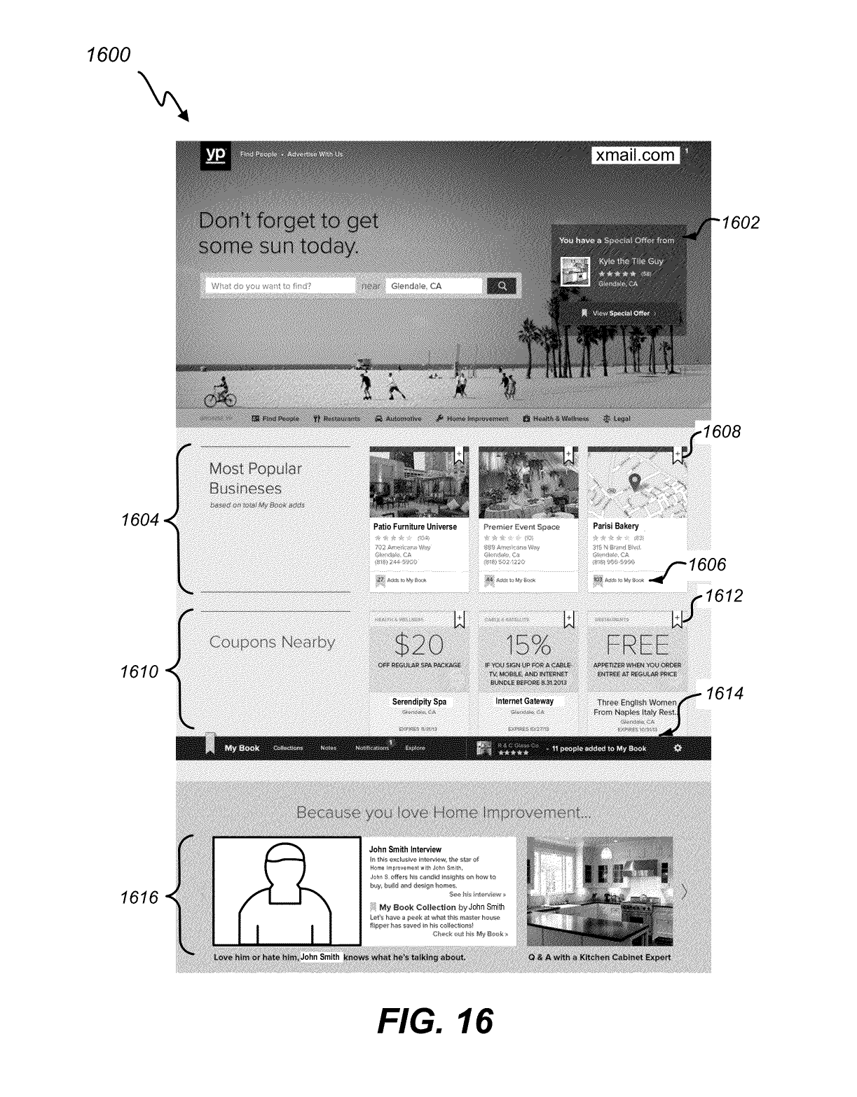

FIG. 16 shows a screenshot, which may be a partial screenshot, of an end-user interface 1600 that may be displayed via a mobile application, webpage, or any suitable end-user interface 105, in accordance with certain embodiments of the present disclosure. The end-user interface 1600 may be similar to other interfaces described herein and may include any one or combination of features of other interfaces described herein. In some embodiments, the end-user interface 1600 may include one or more targeted advertising windows 1602.

The targeted advertising window 1602 may allow for presentation of advertising offers that are targeted to the user. The targeted advertising window 1602 may allow for a business to have an option of deciding to which consumer to send offer information and/or which offer information to send. With some embodiments, a targeted advertising option may be made available to businesses that have been added to a collection of the user. In some embodiments, the targeted advertising could be customized to the consumer by the business. Thus, a business could develop and/or maintain a relationship with the user after the collection addition by pushing a special offer to the user. For example, say a particular business has been added to a collection, but no further engagement between the consumer and the business has ensued. Noting this, the business may wish to have the option to direct one or more offers to the consumer in order to incentivize further engagement. Similarly, say a particular business has been added to a collection and has done business with the consumer, the business may wish to have the option to follow up with the consumer with directed offers to maintain and/or develop the relationship with the consumer. Perhaps, the business has not had contact with the consumer in a while; noting this, the business may wish to send a special offer to the consumer. The targeted advertising information could include one or more of an electronic coupon (which could correspond to a savable and/or printable discount coupon), advertising information, promotion information, offer information, business card information, any suitable business-related information, and/or the like. In various embodiments, in addition or alternative to the targeted advertising window 1602, an advertiser may have any one or combination of options for presenting offers, including via email, text messaging, a mobile app, a website, linked online social/business networking service(s), regular mail, push notifications, telephonic notification, etc.

In some embodiments, the end-user interface 1600 may include one or more selected business windows 1604. The selected business windows 1604 may present certain business information windows for businesses that the user has not already added to a collection. With some embodiments, as in the example depicted, business information may be selected for presentation as the most popular businesses based on total collection additions. Business windows could be selected for presentation based at least in part on one or more of business location(s) in relation to a location of interest to the user, relevance of a business to an identified interest of the user, a number of collection additions by other users with respect to particular businesses, a number of collection additions by other users who are related to the user via online social/businesses networking service(s), trending of such collection additions with respect to a particular time period(s), ratings of businesses, and/or the like. The selected business windows 1604 may include collection addition indicators 1606, as described herein. Along with each selected business window 1604, a user-selectable option 1608 may be presented to the user so that upon user selection, e.g., a single click, a particular business may be added to the user's collections. In some embodiments, the selected business windows 1604 may be selected regardless of what has already been added to the user's collections, and whether a particular business has been added to the user's collections could be graphically indicated in any suitable manner (e.g., though not depicted as such, an indicator 1608 for a business already in the user's collections could be different than an indicator 1608 for a business not already added).

In some embodiments, the end-user interface 1600 may include one or more selected coupon windows 1610. In some embodiments, the selected coupon windows 1610 may present certain coupon information for businesses near a location of interest to the user. In some embodiments, the system 102 could select the coupon information by actively monitoring location of interest data of the user and correlating that data to coupon information retained by the system 102. In some embodiments, coupon information could be correlated to businesses already added to the user's collections in order to apprise the user of pertinent offers relating to those businesses of interest. In some embodiments, the system 102 could monitor location of interest data for the user and notify businesses already added to the user's collections of an opportunity to direct coupon information to the user. Responsive to the notification, a business could provide coupon information to the system 102 for presentation to the user. In some embodiments, the system 102 may gather, push, and/or pull coupon information from businesses, business websites, and/or any suitable data source 100 in any suitable way, and then provide pertinent coupon information to users via one or more selected coupon windows 1610. The selected coupon window 1610 could be configured to provide an electronic coupon that could be savable and/or printable. Along with each selected coupon window 1610, a user-selectable option 1612 may be presented to the user so that, upon user selection (e.g., a single click), the coupon may be saved in association with the user's account. If the corresponding business is already added to the user's collections, the coupon information could be retained and accessible in association with the corresponding business in the appropriate collection. In some embodiments, if the corresponding business is not already added to the user's collections, selection of the option 1612 could also add the corresponding business to the user's collections, in conjunction with retaining the coupon information for later access in association with the corresponding business.

In some embodiments, the end-user interface 1600 may include an activity reporter 1614. The activity reporter 1614 could include one or more widgets, in some embodiments. The activity reporter 1614 may be configured to a report activity about the orchestration platform as the activity is occurring in real-time and/or at a high speed. The activity reporter 1614 may report any suitable information regarding any suitable activity, such as collection additions, new users joining the orchestration service, new reviews, new businesses joining the service, new followings of public collections, etc.

In some embodiments, the end-user interface 1600 may include an editorial section 1616 that may surface editorial content. As in the example depicted, the editorial section 1616 could expose promotional/editorial material that incorporates links to a public collection. The public collection could correspond to a collection associated with a celebrity, and could be tied to one or more endorsements. The public collection could be made available for public viewing, following, sharing, and/or copying.

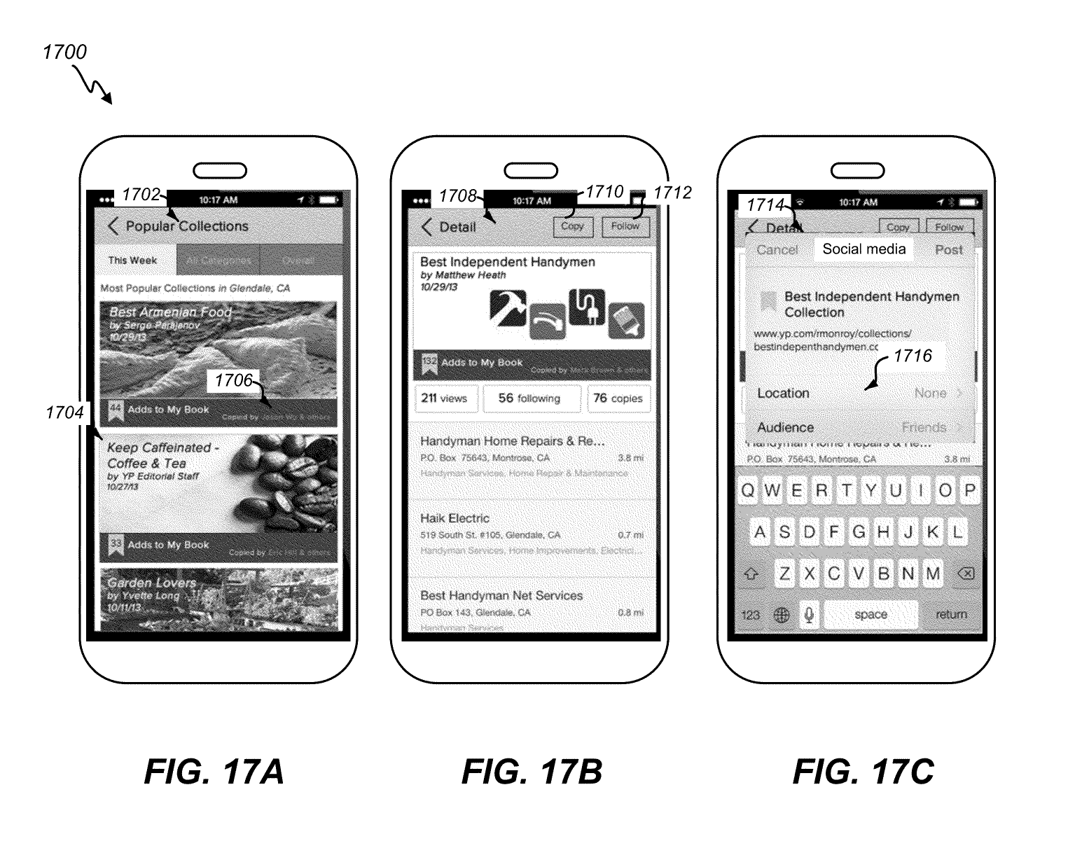

FIGS. 17A, 17B, and 17C are screen displays illustrating example end-user interfaces 1700, in accordance with certain embodiments of the present disclosure. The end-user interfaces 1700 may be displayed via a mobile application or any suitable end-user interface 105 in various embodiments. The end-user interfaces 1700 may be similar to other interfaces described herein and may include any one or combination of features of other interfaces described herein. In some embodiments, the end-user interfaces 1700 may include one or more popular collections windows 1702. In various embodiments, the system 102 and/or the end-user device 300 may be configured to identify location information corresponding to the current or recent location of the end-user device 300 and/or user, and use the location information as a basis for identifying geo-aware selections for indication via the end-user interfaces 1700. In addition or alternative to the location information and relative business location(s) as bases, collections may be selected for presentation to the user based at least in part on relevance of a business to an identified interest of the user, relevance of a business to an identified demographic aspect of the user, how many users are following the collections, positively trending collections with respect to a particular time period(s) (which trending could be based on collection additions, collection followings, ratings, and/or any suitable basis), activity in the collections, ratings of the collections (which could include user votes for collections), instances of sharing of the collections, copies of the collections, and/or the like. Thus, certain embodiments may provide for temporal windowing may allow a user to see businesses trending in the user's neighborhood, city, and/or other local area.

As indicated by collection 1704, certain collection may not be created by and users but may be created and curated by staff of the orchestration service in some embodiments. In conjunction with such staff-curated collections, feedback from the crowd/community may be solicited. For example, incentives may be provided so that users provide feedback on certain collections corresponding to geographical area and business category. In some cases, users may be enticed to add businesses to such a collection. Those that bubble to the top of such a collection (e.g., in terms of ratings, additions, shares, copies, and/or the like) may be given greater visibility in the collection and/or otherwise via the orchestration service features.

In some embodiments, celebrity collections may be available for public viewing, following, sharing, and/or copying. In some embodiments, particular businesses, which may include individual or groups of service providers, may have collections tailored for clients. For example, a real estate agent the curate the collection of local vendors tailored for sharing with clients that have bought or in the process of buying a house in a particular area. Such a collection could include recommended vendors that could be of use to such clients, such as an inspector, a handyman, a pool service, utility providers, lawn care service, housecleaning service, etc. Additionally, the real estate agent may want to have multiple collections tailored to various categories of clients—clients in certain metropolitan areas, neighborhoods, income classes, etc.

In some embodiments, the system 102 may track instances of collection sharing in order to track referrals. Say, for example, a real estate agent shares a collection with a client, and the client contacts a merchant via the shared collection, for example, via a communication reference provided via the collection, which reference could be a click-to-call reference, click-to-message reference, click-to-email reference, click-to-chat reference, and/or the like. The application and/or system 102 could monitor for such communications made via the collection. The system 102, being notified of such communications, may retain tracking information, which could be used as a basis for rewarding the real estate agent for the referral. In some embodiments, for example, an account of the real estate agent could be automatically credited with a referral reward in any suitable form for the lead that was delivered. Beyond the example of a provider having an incentive to provide referrals, the end user could similarly be incentivized to give referrals by sharing of collection/window information. Such incentives may be based on end-user qualification, scoring, and monetization discussed herein.

In some embodiments, a network-specific indicator 1706 may indicate whether a particular collection has been added by others who are friends/associates of the user via an online social/business networking service, other users who associated with a certain affinity group, and/or the like. The network-specific indicator 1706 may identify one or more of the friends/associates. In some embodiments, the end-user interfaces 1700 may provide collection-specific detail information 1708, copy options 1710, and/or follow options 1712, as described herein. The end-user interfaces 1700 may provide one or more collection share options 1714 configured to allow sharing of collection information in any suitable manner, as described herein. For example, as indicated in FIG. 17C, a collection could be shared via social/business networking services account postings, and the collection share options 1714 may facilitate that. In some embodiments, the collection share options 1714 may include user-selectable options 1716 to restrict the posting to a certain audience. Additionally, the user-selectable options 1716 may provide the option to geographically restrict the posting to an audience associated with a certain geographical area. The system 102 may, for example, only make the posting to those friends/associates who have associated locations, as indicated by a social/business networking service, within a particular vicinity corresponding to the user-specified location.

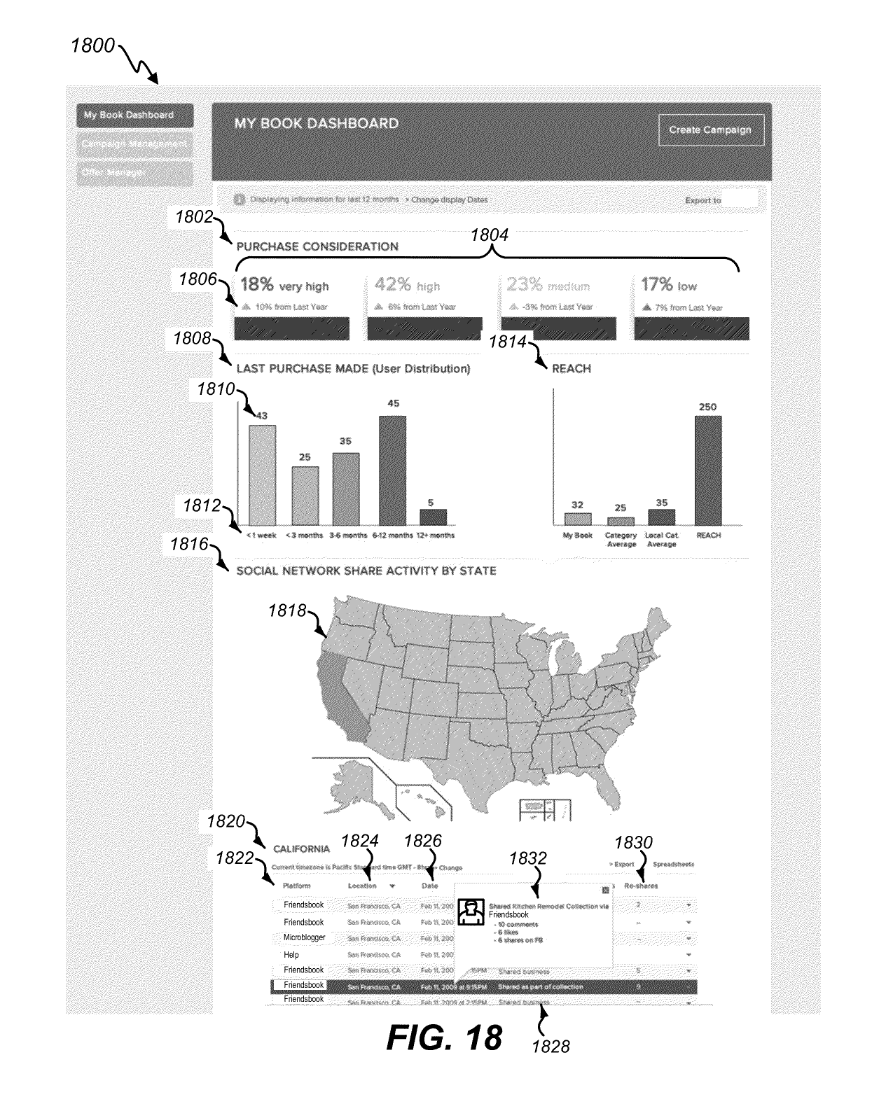

FIG. 18 illustrates one embodiment of a merchant dashboard 1800 for an advertising platform that may correspond to a provider interface(s) 700, in accordance with certain embodiments of the present disclosure. The merchant dashboard 1800 may provide a particular merchant (i.e., a provider 106) access to demographic information about orchestration service users that have added the merchant's business to their collections. In some embodiments, the dashboard 1800 may correspond to a home page that a provider 106 might see upon initialization of an app or logging on to the platform. After a provider 106 logs in, different data points that can be of use to provider 106 may be presented via the dashboard 1800. The dashboard 1800 may include any software process or module operable to present and receive information to/from a provider 106, allow a provider 106 monitor advertising information, select different types of advertising data, identify desired metrics, automatically generate dashboard views, customize dashboard views, and/or the like. The dashboard 1800 may provide a graphical user interface (GUI) that includes any number and type of user-selectable options to facilitate various embodiments. In various embodiments, one or more user-selectable options may include one or more of a screen-labeled function key, an icon, a button, a soft button, a window, a menu, a control widget, a scroll bar, a slider, a listbox, and/or the like. In various embodiments, one or more user-selectable options may be selectable via one or more of touch, push, movement-based selection, and/or any suitable navigation feature. The example of the dashboard 1800 is not limiting, but may be illustrative of a mobile application and/or web interface 107.

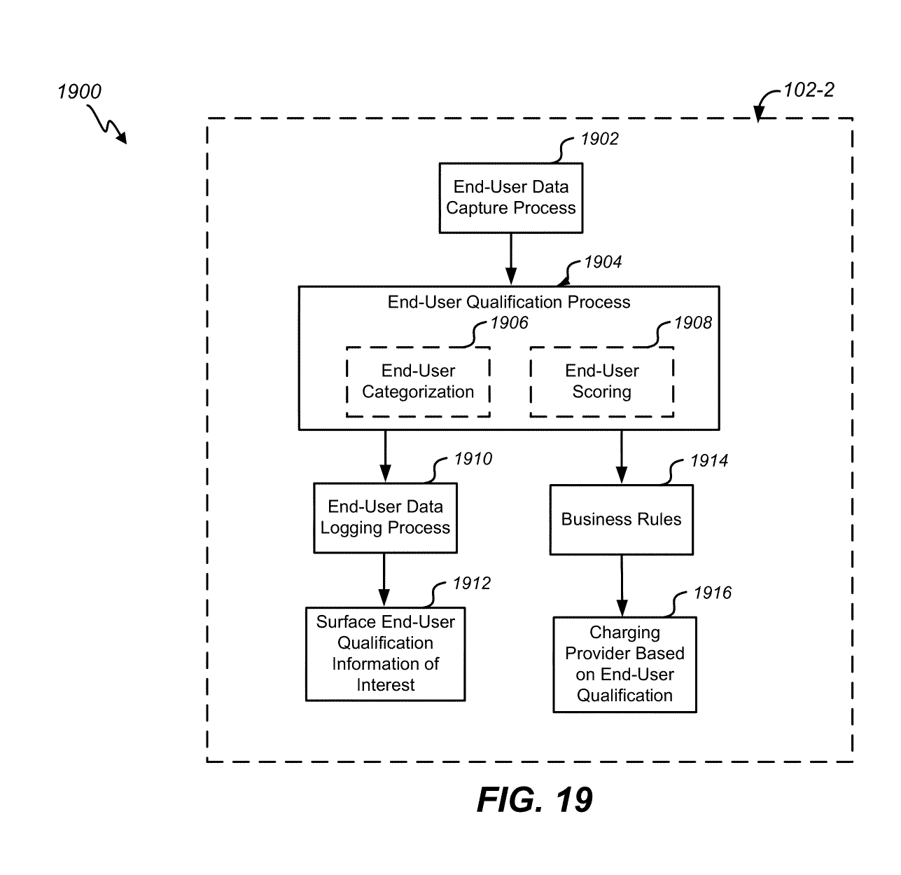

In some embodiments, the dashboard 1800 may expose purchase consideration data 1802 about users who have added the particular merchant to their collections. A purchase consideration metrics feature may be configured to present access to details regarding any suitable aspects of consumer data capture and consumer qualification. FIG. 19 depicts a functional block diagram of certain aspects of end-user qualification 1900, in accordance with certain embodiments of the present disclosure. Various embodiments may employ any one or combination of various methods of qualifying end users. In some embodiments, an end-user may be simply identified as one having, or not having, made a purchase, engaged services, and or otherwise conducted business. In some embodiments, providers may be charged by the orchestration or other service based at least in part on such an identification.

Captured data may be used to qualify and users. End-user data may include any suitable information that may be captured to indicate, infer, and/or determine which end-users are likely to bring in business and/or actually have brought in business. An end-user's interactions with the orchestration platform can be broken down and assessed based on any one or combination of various factors, such as, for example, duration of various directed interactions, locations of the end user relative to business locations, demographic information of the end user, collection/window development by the end user, content added by the end user, communications with merchants, keyword analysis user-generated content and/or communications, and/or the like. Based on such indicia, an end user can be qualified.

Some embodiments may employ a decision tree, checklist, workflow, and/or the like to capture various aspects of consumer qualification data and assess those aspects to infer consumer qualification. Such a decision tree, checklist, and/or workflow may incorporate any one or combination of the depicted aspects and/or similar aspects in any desired order, according to various embodiments. End-user qualification data can be consolidated and processed to yield an end-user qualification score. Any one or combination of types of end-user data may be captured, analyze, and qualified.

The system 102-2 may receive and process data regarding an end-user in implementing the end-user data capture process 1902. In some embodiments, the system 102-2 may analyze any information received from an end user, which information may be associated with the end-user account and retained by the system 102-2 to provision orchestration service features to the end user. As discussed herein, certain embodiments may use a client application installed on the end-user computing device 105 to facilitate data capture. The end-user data capture process 1902 may include any one or combination of various embodiments as discussed herein that gather information.

Having end-user data, the system 102-2 may implement a lead qualification process 1904. The system 102-2 may be configured to qualify end users in whole or in part. Though certain aspects of end-user qualification 1900 are depicted as being performed by the system 102-2, the processes for qualifying end users may, in some embodiments, be performed in whole or in part by a client application 351 installed on the end-user computing device 105 and/or the provider computing device 97.

Some embodiments may qualify an end-user according to a graduated scale. Any suitable scale may be used in various embodiments. In some embodiments, a scale could entail a categorization scheme 1906, with any suitable categories. For example, as depicted in FIG. 18, categories 1804 such as very high, high, medium, and low could be used to segment end users by purchase consideration.

Referring again to FIG. 19, in some embodiments, a scale could entail an end-user scoring system 1908. The end-user scoring system 1908 could be correlated to the category scheme in some embodiments, such that certain scores correspond to certain categories. Some embodiments may score an end user with a numerical expression, for example, an end-user score. An end-user score may be an assessment of an end-user's potential to engage a merchant and conduct business. Accordingly, an end-user score may indicate which end users are more likely than others to bring in business, thus providing a quantitative estimate of the probability that a given end user will provide business. By way of example without limitation, a scale could include a range of end-user scores from 0 to 90, or from 0 to 1,000, with the high end of the scale indicating greater probability. Some embodiments may use methods of statistical analysis to derive an end-user score. Various embodiments may determine an end-user score based on any one or more suitable quantifiers.

In some embodiments, the system 102-2 may implement an end-user data logging process 1910 which gleans data pertinent to qualification from end-user data associated with the end-user account. The system 102-2 may generate and maintain an end-user qualification profile that may include any suitable qualification information corresponding to a particular end user. As indicated by block 1912, any suitable end-user qualification information of interest may be surfaced, for example, by way of the merchant dashboard 1800. For example, information about end users that have added a particular provider to collections could be compiled, analyzed, formatted, and/or otherwise processed to window any analytics of interest.

In some embodiments, the system 102-2 may implement business rules 1914 to take action based at least in part on the end-user qualification. The provider advertising with the orchestration/listing service could be charged based on the end-user qualification 1916 in some embodiments. The account management/billing module(s) 112(f) could implement a code system by which a provider is charged based on the end-user qualification. For example, a provider could be charged differently based on whether end-users are more or less qualified. The charging process could be a performance-based system where charges based on an addition of a provider to an end-user collection and/or based on end-user actions taken with respect to the particular provider thereafter.

In some embodiments, the charges could be based on end-user score. Charges could be proportional to end-user score in some embodiments. Charges could be applied contingent on one or more thresholds. For example, a minimum threshold could be employed, where an end-user score not meeting the minimum threshold could result in no charge. An end-user score above the minimum threshold could result in a charge. The charge could be based on one or more score bands, for example, one or more score bands above the minimum threshold. By way of example, an end-user score above a 50% minimum threshold could be correlated to quartile bands. A discounted charge could be applied based on an end-user score correlated to a 50-75% band. A full charge could be applied based on an end-user score correlated to the 75-100% band. Some embodiments could implement a proportional charge, such as an end-user score correlated to 75% could result in a charge of 75% (or some other proportion) of the full charge.

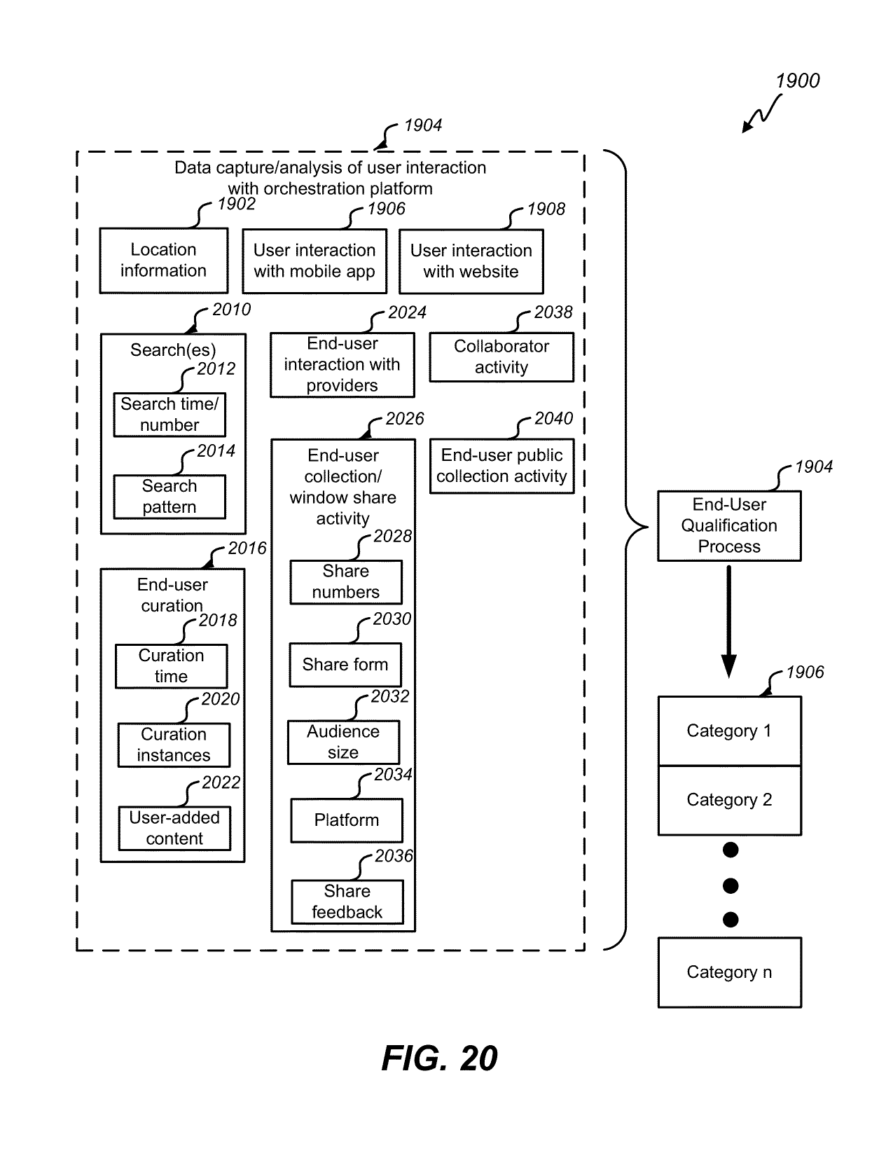

FIG. 20 depicts a functional block diagram 2000 of certain aspects of end-user data capture, analytics, and qualification, in accordance with certain embodiments of the present disclosure. The criteria for qualifying consumers may take into account the extent of end-user interaction. A greater extent of interaction could increase a ranking assigned to a particular user. The user interaction considered may include one or more of interaction directed to the merchant, the business area of the merchant, and/or other merchants related to the merchant's business area. The criteria for qualifying consumers may take into account the extent of user interaction with a collection and/or information window associated with the merchant, the business area of the merchant, and/or other merchants related to the merchant's business area. The qualification of a particular consumer may also be weighted as a result of keywords being used in communication and/or commentary associated with a collection and/or window related to the merchant—e.g., the keywords may indicate a user ready to buy, engage services, and/or otherwise conduct business. The qualification of a particular consumer may be weighted more heavily as a result of indicia that the consumer made a purchase, engaged services, and or otherwise conducted business.

As indicated by block 2002, in some embodiments, location information may be captured to provide an indication of the end user's location. As discussed herein, various embodiments may employ any one or combination of methods of capturing location information, including but not limited to, gathering location information via any one or combination of the end-user orchestration platform profile, the communication device 105, 300, such as the device GPS capabilities, access points, third-party data sources, determining the area code associated with the device, differentiating between whether a caller uses a landline or wireless network, receiving explicit location information with one or more search requests, inferring location information from one or more search requests, and/or the like. Gathering of location information may be facilitated by the application 351 of the end-user device sending tracking information to the system 102. In some embodiments, gathering of location information may be performed before an end-user places a call, for example, via the mobile application. Various location quantifiers could be assigned to a user based on the business of interest. For example, with some businesses, proximate location of an end user is important, say, for a plumber for example. With other businesses, proximate location of an end user may not be so important, or the fact that an end user travels frequently may be more important some businesses, for example, businesses which tailor to travelers. As an example, a number of points could be assigned to the end user based on an identification of the importance of proximity to the business/category of interest and the location information gathered for the end user.

In some embodiments, as indicated by block 2004, an end user's interaction on the orchestration platform may be captured as data of interest. For example, as indicated by blocks 2006 and 2008, in some embodiments, end-user interaction with the mobile application 351 and/or website provided by the system 102 may be captured. As indicated by block 2010, the user interaction may involve one or more searches. A user, for example, may spend significant time searching for businesses relating to a certain category. As indicated by block 2012, the amount of time and/or the number of searches may be taken into account as an indicator of relatively greater interest. The time spent searching a particular category of service providers and/or the number of searches could be correlated to an increased indicator of interest in any suitable manner. Merely by way of example, a number of points could be assigned to an end user based on the time spent searching and/or the number of searches. Various interest quantifiers could be assigned to an end user based on search time in a proportionate manner. For example, a number of points could be assigned for every minute of search time. Various interest quantifiers could be assigned to an end user based on the user meeting any one or combination of various thresholds of search time. As an example, a number of points could be assigned after the end user accrues 5 minutes of search time.

As indicated by block 2014, in some embodiments, a search pattern may be taken into account as lead data of interest. The search focus or non-focus may be considered. Certain embodiments could differentiate between searches to detect a pattern of searches corresponding to a given category of searches. For example, an end user might spend 5 minutes of searching, viewing results, linking to provider websites, reading reviews, etc., all related to a particular category of service providers, say plumbers in a particular geographic area. Such search time could be distinguished from non-focused searching, such as searching related to various categories, which might not be related. In such cases, no additional points or lower number points may be assigned.

As indicated by block 2016, in some embodiments, end-user curation may be taken into account as end-user data of interest. End-user curation 2016 may be assessed in terms of curation time 2018. For example, time spent arranging and customizing a collection and/or information window maybe taken as a higher level of interest and be assigned points accordingly. Time spent accessing, editing, and/or augmenting a collection and/or information window may be taken as an indication of interest and be assigned points accordingly. End-user curation 2016 may be assessed in terms of curation instances 2020. For example, instances if arranging, customizing, editing, and/or augmenting a collection and/or information window may be gauged to determine interest. End-user curation 2016 may be assessed in terms of user-added content 2022. User-added notes and/or reviews, for example, could be assigned certain points, with more extensive notes/reviews being assigned a greater amount of points. As another example, instances of user-added photos and/or images may be assigned points accordingly. User-added photos and/or images that correspond to receipts, invoices, warranties, etc. may be identified as evidence that the end-user has transacted business with a merchant, thus evincing a greater level of interest. Other user-added content that could be assessed may include any other suitable user added content discussed herein, including ratings indicia, preference indicia, etc.

As indicated by block 2024, in some embodiments, an end user's interaction with one or more other merchants via the orchestration platform could be assessed and assigned points accordingly. For example, if a user adds a merchant as a collaborator or otherwise allows a merchant to view a collection, then that situation may be taken as an indicator of a high level of interest. As another example, if a user communicates with a merchant via the platform (e.g., via a type of click-to-contact link, chat window, email, text, and/or like means that is facilitated by the orchestration platform and/or links thereto), that likewise can be taken as an indicator of interest. An end user's interaction with one or more other merchants could be assessed based on instances, repeated engagements with specific merchants, frequency of interaction (with merchants of a certain business type, e.g.), duration of interaction, type of interaction, and/or the like.

As indicated by block 2026, in some embodiments, an end user's collection/window share activity could be assessed and assigned points accordingly. Instances of sharing could be assessed based on numbers of occurrences 2028, form of sharing 2030, the size of the audience 2032 to whom the information shared, the platform 2034 to which the information shared, feedback on shares 2036 by others (e.g., in the form of preference indicia, reviews, re-shares, etc.), and/or like. As indicated by block 2038, in some embodiments, an end user's collaborator activity could also be assessed, with instances/numbers of collaborators being taken into account.

As indicated by block 2040, in some embodiments, an end user's public collection share activity could be assessed and assigned points accordingly. Instances of collection publicizing could be assessed based on numbers of occurrences, numbers of followers, instances of copying, feedback on public collections by others (e.g., in the form of preference indicia, reviews, etc.), and/or like.

With regard to any of these bases for qualification or similar bases, scoring or otherwise assigning significance to such bases may be implemented to any suitable level of granularity. For example, with respect to feedback on shares 2036, type of feedback and extent of feedback can be differentiated and accorded various levels of significance. As a specific example, a simple indication that a friend/connection of the end user likes something that the end user shared on a social/business network may be accorded less significance than a re-share and/or comment by a friend/connection. Similarly, not all comments need be treated the same. In some abundance, keyword analysis such as described herein may be used to assess the significance of comments made by friends/connections.

Accordingly, various embodiments according to the present disclosure may provide for windowing end-user analytics that can provide market insights to providers. Moreover, various embodiments may qualify end-user aspects of the orchestration platform so that expansion, collaboration, sharing, and/or other use of the orchestration platform may be monetized (e.g., based on end-user qualification analytics). Such monetization can be used to incentivize sharing, marketing efforts, endorsement efforts, and/or other use of the orchestration platform. And, the incentive position may take the form of a reward system, be it monetary or otherwise.

Referring again to FIG. 18, the purchase consideration data 1802 about end users who have added the particular merchant to their collections could be presented based on the end-user qualification information analytics. The purchase consideration data 1802 could correspond to any time period(s). Additionally, the purchase consideration data 1802 could compare to past data. The past data could also be presented, however, like in the example depicted, differential information 1806, such as percentage increases/decreases, could be presented. In addition to segmented analytics information about multiple end users, any suitable information about individual end users, such as a qualification score, underlying qualification data, and/or the like, could be viewable, for example, responsive to user selection of one or more user-selectable options.

Other end-user analytics that could also be presented may include purchase information 1808. For example, the purchase information 1808 may take into account purchases made by respective end users. A last purchase of each respective end user may be taken into account, and a user distribution of numbers of end users 1810 who have made last purchases over any suitable time period of interest 1812 may be presented, like in the example 1808 indicated. In various embodiments, the purchases considered could be purchases made with the particular merchant, with other competitor merchants that end users have added to a collection and that are in the same business category of the merchant, and/or with other collection-added merchants generally.

The dashboard 1800 may provide one or more user-selectable time options. A time period selection feature may be configured to allow for selection of a time period for which to view certain performance metrics. Past performance, current performance, and projected options may be provided. Past performance could show performance metrics for past week, month, billing period, three months, six months, year, etc. Current performance could show real-time performance in the context of recent activity such as the last hour, day, week, etc. Projected performance could show extrapolation of past and/or current performance data into future, such as any coming time period. Projected performance could be based on any suitable factor, including aggregate performance of competitors in the market, publisher/platform performance, market data for a particular location, and/or the like.

Other end-user analytics that could also be presented may include reach information 1814. The reach information 1814 may include information about the number of users reached. The reach information 1814 could indicate one or more of users reached by a particular merchant, by merchants corresponding to a particular category (e.g., a service category, a product category, any suitable business category, etc.), by merchants corresponding to a particular locale, and/or the like. Such reach information 1814 could be graphically differentiated along any suitable lines. The reach information 1814 could be refined to expose reach information for any suitable time period, which time period could be user-selectable. The reach information 1814 could be differentiated based on specific platforms used. For example, users reached via the orchestration platform could be distinguished from users reached via social network connections. The reach information 1814 could include any share activity described herein. The reach information 1814 could reflect users who have specifically added a particular merchant to a collection. The reach information 1814 could also reflect users who have visited a particular merchant website, contacted a particular merchant, and/or otherwise linked to a particular merchant via the orchestration platform. Any one or combination of reach information 1814 items could be qualified according to any suitable bases, e.g., demographic information, visit number, value of customer, potential value of customer, quality of leads, social network connections, customer score, etc. And, such qualification could be graphically presented/distinguished in any suitable manner.

Other end-user analytics that could also be presented may include share activity information 1816. Any suitable share information may be gathered, analyzed, and windowed. The share activity could correspond to sharing of window information for a particular merchant, which could correspond to sharing based on an individual window and/or sharing based on a collection that includes window information for the particular merchant. The share activity could correspond to sharing between users of the orchestration platform. The share activity could correspond to sharing by a user of the orchestration platform to a non-user via any one or combination of the various means described herein. In the example depicted, the share activity information 1816 may correspond to sharing via one or more social networks.

The share activity information 1816 may be segmented by geography, like in the depicted example. While the example depicts segmentation by state, any suitable geographic segmentation may be employed in various embodiments, including neighborhood, city, metro area, county, and/or the like. In some embodiments, one or more user-selectable options may be provided for user-specified geos of interest to analyze data corresponding to the user-specified geos. For example, a user may be able to indicate a range, such as a radius of X miles from specified location of interest. In some embodiments, a user could indicate an area of interest with any suitable parameters, e.g., including one or more counties, municipalities, zip codes, distances from reference points, etc. In some embodiments, a user-selectable map interface 1818 may be presented. Some embodiments may enable a merchant user to define an area by selecting one or more points on the map interface 1818. For example, any predefined service areas, such as zip codes and/or the like, could be presented on the map for selection. The map interface could allow a user to define a perimeter of a service, e.g., by drawing on the map with a line drawing tool, cursor, finger/stylus contact with a touch interface, selection of perimeter boundaries such as roads, rivers, etc. Hence, share indicia may be location-specific and windowed in any suitable degree of granularity to provide enhanced relevance.

In the example 1818 depicted, user-selectable options may be presented for selecting share activity information by state. Consequent to user selection, geo-specific information 1820 may be presented. The geo-specific information 1820 may include any suitable details regarding the share activity. The share activity details may include one or more of platforms 1822 to which shares were directed, locations 1824 associated with the sharing end user, dates 1826 on which the shares occurred, times 1826 at which the shares occurred, distinctions 1828 as to whether the shares were individual business shares or collection shares, information on re-shares 1830, specifics as to collections shared 1832 (which may include one or more of comments received, ratings received, approval/disapproval indicia received, re-shares be a particular platforms, etc.), and/or the like. The share information presented with the merchant dashboard 1800 may be presented in any suitable manner. User-selectable options may be provided for exporting/converting the share information, in whole or in part, and to any desired format, including spreadsheets and other commonly used document formats.

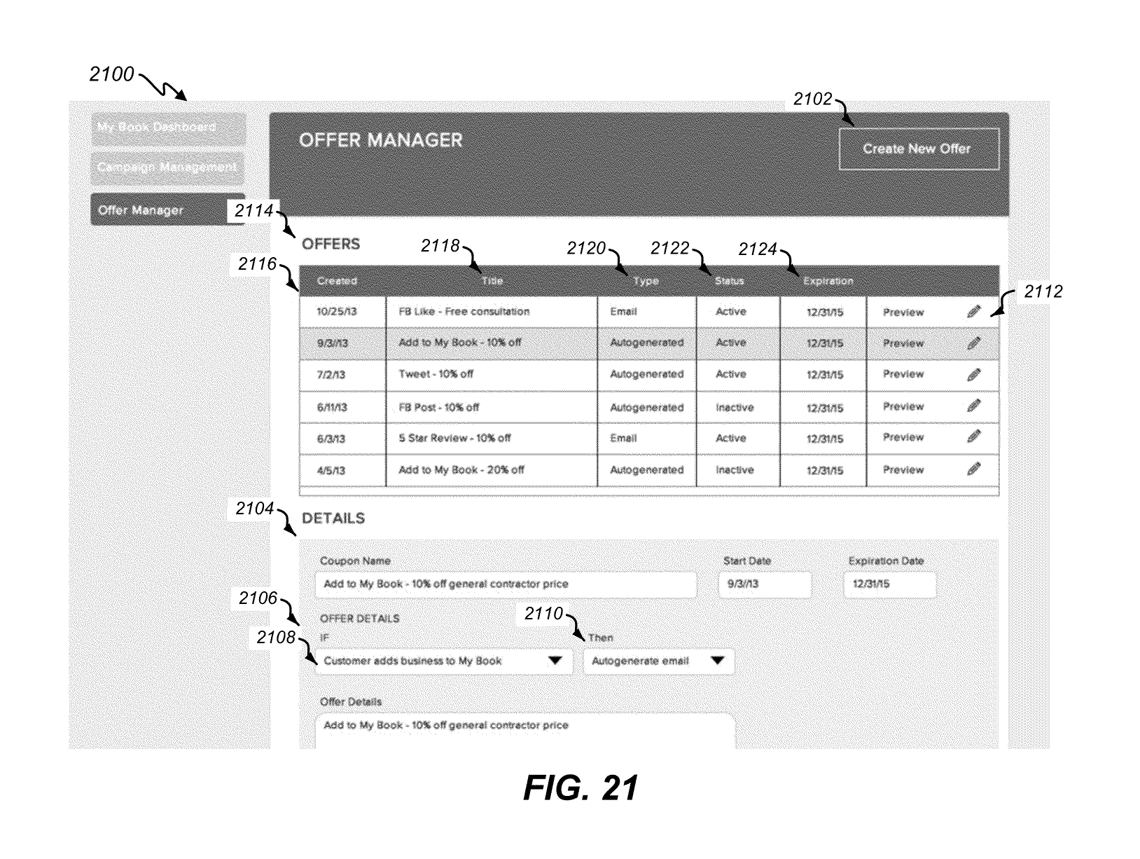

FIG. 21 illustrates one embodiment of an offer manager 2100 for an advertising platform that may correspond to a provider interface(s) 700, in accordance with certain embodiments of the present disclosure. The offer manager 2100 may be provided in conjunction with the merchant dashboard 1800. The offer manager 2100 may allow for the creation of an advertising profile and may be configured to facilitate marketing automation. With an advertising profile, a merchant may be able to indicate specific offer information for provisioning to end users of the orchestration platform. An advertiser profile may include persistent offer provisioning information that is maintained for subsequent offer provisioning based on one or more trigger events. An advertiser profile may be retained in the one or more repositories 128.

One or more user-selectable options 2102, which may include workflows, may be provided via the offer manager 2100 to allow a merchant to create and/or designate certain offer information. In some embodiments, one or more templates 2104 may be provided for selection and/or input of desire details. Various coupon templates could be provided by the system 102 and presented to allow a choice of one or more templates. The various coupon template options could differ in terms of style, content, form, and/or the like. A coupon template 2104 could include fields for entry of information by the merchant. For example, the merchant may have an option to designate a service and/or product, offer/discount information, start date, expiration date, terms and conditions, and/or any suitable information to facilitate offer information provisioning. In some embodiments, the system 102 may at least partially populate a template with merchant information based at least in part on listing information and/or previous offer information already retained for a specific merchant. For example, a template could be pre-populated with merchant information such as business name, business location, and/or the like. In cases where there are multiple options for a given advertiser (say, multiple locations, multiple goods/services, and/or the like), the system 102 could identify those options and facilitate user-selectable options for the merchant to designate.

In some embodiments, a merchant may upload information for use in offer provisioning, and the offer manager 2100 could be configured to provide user-selectable options to facilitate such uploading. A merchant could upload any suitable offer information in any suitable form in various embodiments. For example, a merchant could upload an electronic coupon, images and/or other graphical/video data, audio data, and/or the like. Such uploaded data could correspond to any suitable advertising content.

In some embodiments, a merchant may be provided with options to designate certain business rules 2106 for offer information provisioning. Such business rules 2106 could specify one or more temporal conditions, such that provisioning may depend on one or both of temporal condition(s) and trigger events. Temporal conditions could include one or more of time parameters, day parameters, date parameters, location parameters, and/or the like that could be conditions for offer provisioning. Business rules 2106 specifying time parameters could include, e.g., rules for handling provisioning in view of a time of day when a trigger event occurs. Business rules 2106 specifying day parameters could include, e.g., rules for handling provisioning in view of a day of the week when a trigger event occurs. Business rules 2106 specifying date parameters, e.g., could include rules for handling provisioning in view of a date on which a trigger event occurs. Any suitable interface features, including input fields, telephone dialer inputs, IVR inputs, and/or user-selectable clock, calendar, and/or like GUI components could be provided to facilitate advertiser specification of business rules in various embodiments.

Business rules 2106 specifying location parameters could include, e.g., rules for handling provisioning in view of a location identified for an end user. Accordingly, with an advertiser profile, a merchant may be able to indicate specific areas for which particular offer provisioning to be targeted. In various embodiments, a target area could be specified in any suitable manner, including, for example, by one or more counties, municipalities, zip codes, distances from reference points, etc. In some embodiments, a user-selectable map interface may be presented as described herein.

Business rules 2106 specifying trigger event(s) 2108 could include, e.g., rules for handling provisioning in view of any one or combination of events associated with an end user's orchestration account. For example, trigger events 2108 could include one or more of an end user adding a business to a collection, a forming of a new collection around a theme, an addition of collaborator (e.g., adding a merchant as a collaborator), otherwise allowing a merchant to have access to a collection/window, a sharing of a collection and/or business window with another orchestration service user, a sharing of a collection and/or business window with a linked account (e.g., email, text message, online social/business networking services—one or more of which could be differentiated with distinct rules for handling sharing with distinct accounts), a copying/following of a collection, making a collection/window public, adding content to a collection/window, a time period since a last activity with respect to a business window, an end user's search relevant to a merchant not already added to the end user's collection, an end user's search relevant to a merchant already added to the end user's collection, a search for other merchants (e.g., a search relevant to a business already added to a collection of an end user, which search could potentially turn up competitors), and/or the like.

Business rules 2106 specifying a form of provisioning 2110 could include, e.g., rules for provisioning offer information via one or more of text messages, voice notifications, push notifications, e-mails, social/business networking services account postings/messages, alerts with the application, and/or other any suitable means. The offer manager 2100 may be configured to present an offer that a merchant has set up for previewing 2112. In some embodiments, the system 102 may subsequently use any one or combination of merchant-specific business rules 2106 to identify appropriate offer information options for one or more of a particular end user, trigger event, and/or conditions. In some embodiments, the system 102 may be configured to automatically provide offer information to an end user based on the merchant-specific business rules 2106 on behalf of the particular merchant without further merchant intervention. In some embodiments, the system 102 may be configured to present automatically identified offer information (i.e., identified based on the merchant-specific business rules 2106) for merchant selection so that the merchant may have the choice as to whether to dispatch the offer information.

In some embodiments, the system 102 can select pertinent offer information for transmission, select a delivery manner/form, and/or transmit pertinent offer information responsive to a trigger event based at least in part on the advertiser profile. In some embodiments, the system 102 may be configured to provide one or more offer information options to a merchant based on the merchant-specific business rules 2106. Accordingly, the system 102 can filter various offer information provisioning options with the merchant-specific business rules and present an appropriate subset of those options to a merchant for merchant selection.

In some embodiments, the offer manager 2100 may include a dashboard summary 2114 configured to present information and user-selectable options for offers retained by the system 102 for the merchant. The dashboard summary 2114 may present information such as offer creation date 2116, offer identification information 2118, specific form of provisioning 2120, offer status 2122, offer expiration 2124, and/or any other appropriate offer information. In some embodiments, the offer manager 2100 may be configured to present offer suggestions. The offer suggestions could prompt the merchant to create offers that the merchant has not already created. For example, offer manager 2100 may identify potential trigger events related to the merchant (e.g., an end user adding the merchant to a collection), and may query the merchant to whether create an offer in view of the potential trigger events.

Accordingly, certain embodiments may provide a merchant with a way to communicate with end users that are not only potential customers, but also potential promoters of the merchant. Certain embodiments may allow a merchant to market events, product offerings, and/or service offerings to end users.

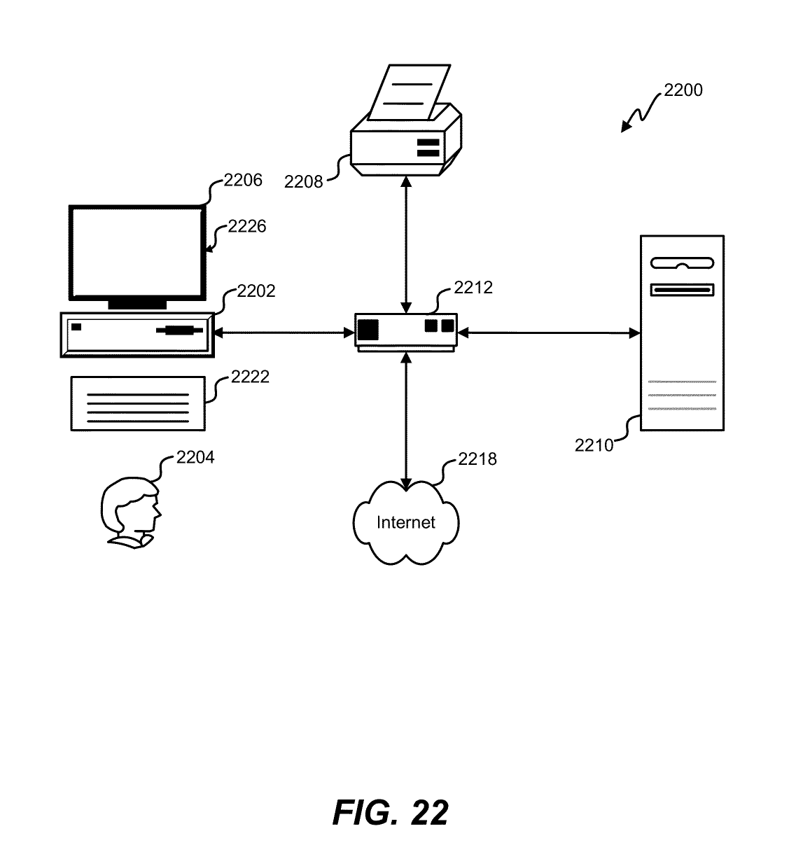

Referring next to FIG. 22, an exemplary environment with which embodiments may be implemented is shown with a computer system 2200 that can be used by a designer 2204 to design, for example, electronic designs. The computer system 2200 can include a computer 2202, keyboard 2222, a network router 2212, a printer 2208, and a monitor 2206. The monitor 2206, processor 2202 and keyboard 2222 are part of a computer system 2226, which can be a laptop computer, desktop computer, handheld computer, mainframe computer, etc. The monitor 2206 can be a CRT, flat screen, etc.

A designer 2204 can input commands into the computer 2202 using various input devices, such as a mouse, keyboard 2222, track ball, touch screen, etc. If the computer system 2200 comprises a mainframe, a designer 2204 can access the computer 2202 using, for example, a terminal or terminal interface. Additionally, the computer system 2226 may be connected to a printer 2208 and a server 2210 using a network router 2212, which may connect to the Internet 2218 or a WAN.

The server 2210 may, for example, be used to store additional software programs and data. In some embodiments, software implementing the systems and methods described herein can be stored on a storage medium in the server 2210. Thus, the software can be run from the storage medium in the server 2210. In another embodiment, software implementing the systems and methods described herein can be stored on a storage medium in the computer 2202. Thus, the software can be run from the storage medium in the computer system 2226. Therefore, in this embodiment, the software can be used whether or not computer 2202 is connected to network router 2212. Printer 2208 may be connected directly to computer 2202, in which case, the computer system 2226 can print whether or not it is connected to network router 2212.

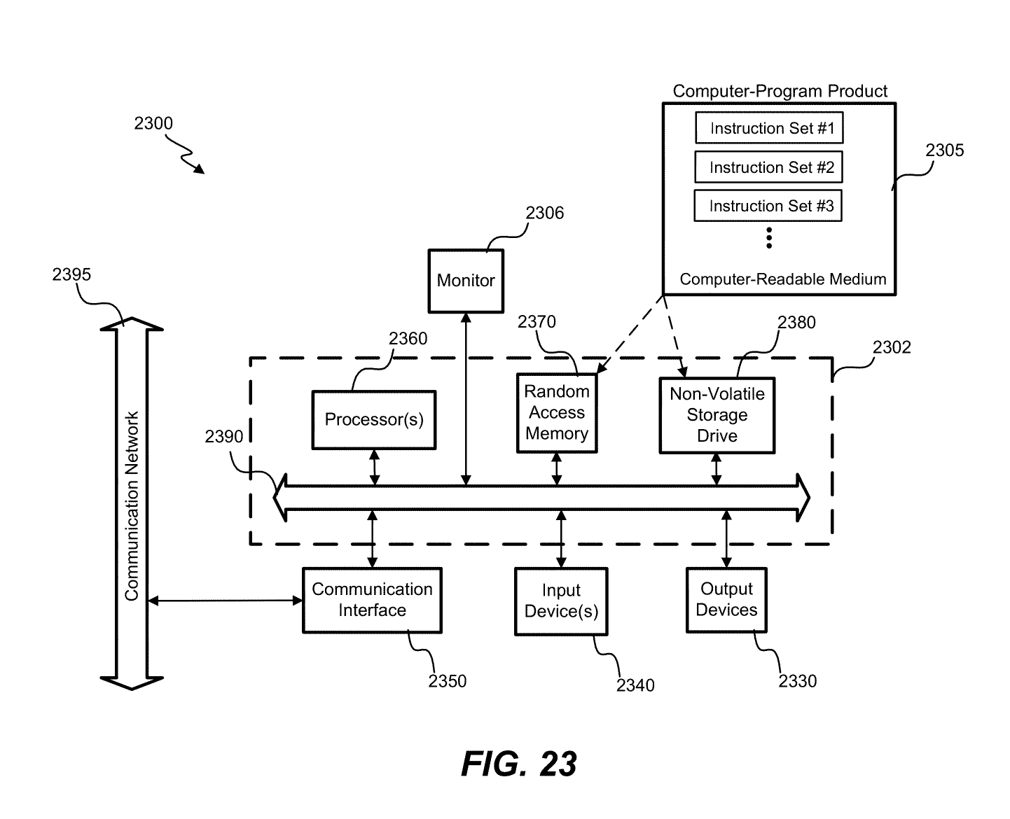

With reference to FIG. 23, an embodiment of a special-purpose computer system 2300 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 2326, it is transformed into the special-purpose computer system 2300.

Special-purpose computer system 2300 comprises a computer 2302, a monitor 2306 coupled to computer 2302, one or more additional user output devices 2330 (optional) coupled to computer 2302, one or more user input devices 2340 (e.g., keyboard, mouse, track ball, touch screen) coupled to computer 2302, an optional communications interface 2350 coupled to computer 2302, a computer-program product 2305 stored in a tangible computer-readable memory in computer 2302. Computer-program product 2305 directs system 2300 to perform the above-described methods. Computer 2302 may include one or more processors 2360 that communicate with a number of peripheral devices via a bus subsystem 2390. These peripheral devices may include user output device(s) 2330, user input device(s) 2340, communications interface 2350, and a storage subsystem, such as random access memory (RAM) 2370 and non-volatile storage drive 2380 (e.g., disk drive, optical drive, solid state drive), which are forms of tangible computer-readable memory.

Computer-program product 2305 may be stored in non-volatile storage drive 2380 or another computer-readable medium accessible to computer 2302 and loaded into memory 2370. Each processor 2360 may comprise a microprocessor, such as a microprocessor from Intel® or Advanced Micro Devices, Inc.®, or the like. To support computer-program product 2305, the computer 2302 runs an operating system that handles the communications of product 2305 with the above-noted components, as well as the communications between the above-noted components in support of the computer-program product 2305. Exemplary operating systems include Windows® or the like from Microsoft® Corporation, Solaris® from Oracle®, LINUX, UNIX, and the like.

User input devices 2340 include all possible types of devices and mechanisms to input information to computer system 2302. These may include a keyboard, a keypad, a mouse, a scanner, a digital drawing pad, a touch screen incorporated into the display, audio input devices such as voice recognition systems, microphones, and other types of input devices. In various embodiments, user input devices 2340 are typically embodied as a computer mouse, a trackball, a track pad, a joystick, wireless remote, a drawing tablet, a voice command system. User input devices 2340 typically allow a user to select objects, icons, text and the like that appear on the monitor 2306 via a command such as a click of a button or the like. User output devices 2330 include all possible types of devices and mechanisms to output information from computer 2302. These may include a display (e.g., monitor 2306), printers, non-visual displays such as audio output devices, etc.

Communications interface 2350 provides an interface to other communication networks 2395 and devices and may serve as an interface to receive data from and transmit data to other systems, WANs and/or the Internet 2318. Embodiments of communications interface 2350 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 2350 may be coupled to a computer network, to a FireWire® bus, or the like. In other embodiments, communications interface 2350 may be physically integrated on the motherboard of computer 2302, and/or may be a software program, or the like.

RAM 2370 and non-volatile storage drive 2380 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 2370 and non-volatile storage drive 2380 may be configured to store the basic programming and data constructs that provide the functionality of various embodiments of the present invention, as described above.

Software instruction sets that provide the functionality of the present invention may be stored in RAM 2370 and non-volatile storage drive 2380. These instruction sets or code may be executed by the processor(s) 2360. RAM 2370 and non-volatile storage drive 2380 may also provide a repository to store data and data structures used in accordance with the present invention. RAM 2370 and non-volatile storage drive 2380 may include a number of memories including a main random access memory (RAM) to store of instructions and data during program execution and a read-only memory (ROM) in which fixed instructions are stored. RAM 2370 and non-volatile storage drive 2380 may include a file storage subsystem providing persistent (non-volatile) storage of program and/or data files. RAM 2370 and non-volatile storage drive 2380 may also include removable storage systems, such as removable flash memory.

Bus subsystem 2390 provides a mechanism to allow the various components and subsystems of computer 2302 communicate with each other as intended. Although bus subsystem 2390 is shown schematically as a single bus, alternative embodiments of the bus subsystem may utilize multiple busses or communication paths within the computer 2302.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A computer-implemented method for personalized orchestration of business information relating to one or more businesses of interest to an identified end user, the computer-implemented method comprising:
processing, by a computer system, first information corresponding to a first business that is associated with an identified end user, the first information being received via a network, and the first business corresponding to a first participant in a listing service;
processing, by the computer system, second information corresponding to a second business that is associated with the identified end user, the second information being received via the network, and the second business corresponding to a second participant in the listing service;
processing, by the computer system, curation information associated with the identified end user, the curation information comprising:
collection information at least partially specifying one or more collection characteristics of collections of business information, each collection of the collections of business information being associated with a respective theme, the collections of business information comprising:
a first collection that is associated with a first theme and that includes the first information corresponding to the first business; and
a second collection that is associated with a second theme and that includes the second information corresponding to the second business; and
window information at least partially specifying one or more window characteristics that comprise one or more user-specific customizations as to how content relating to the first collection and/or the second collection is to be provided to the identified end user, wherein the one or more user-specific customizations were indicated by the identified end user via an end-user computing device;
retaining, by the computer system, the curation information in at least one repository of one or more repositories;
processing, by the computer system, a request initiated by the identified end user to share business information related to the first collection and/or the second collection with a second user, the request being received via the network and specifying one or more of the first collection, the second collection, the first business, and/or the second business;
responsive to the request to share business information:
accessing, by the computer system, the curation information for the identified end user accessing, by the computer system, a set of business information related to the first business and/or the second business, wherein the set of business information comprises business listing information and is retained in at least one repository of the one or more repositories; and
windowing, by the computer system, the set of business information related to the first business and/or the second business, wherein the windowing is at least partially a function of the window information, the windowing comprising:
processing the set of business information related to the first business and/or the second business based at least in part on the curation information for the identified end user to at least partially form a windowed set of information; and
transmitting, via the network, the windowed set of business information to facilitate display of at least part of the windowed set of business information with a second end-user computing device, the second end-user computing device being associated with the second end user that is different from the identified end user.

2. The computer-implemented method for personalized orchestration of business information of claim 1, further comprising:
processing, by the computer system, a second request that corresponds to a request to facilitate information display in accordance with the curation information for the identified end user; and
transmitting, by the computer system, a second windowed set of business information, wherein the transmitting is directed to the end-user computing device or another end-user computing device associated with the identified end user.

3. The computer-implemented method for personalized orchestration of business information of claim 1, wherein the first business and/or the second business were individually selected by the identified user via the end-user computing device.

4. The computer-implemented method for personalized orchestration of business information of claim 1, wherein the windowing the set of business information related to the first business and/or the second business further comprises:
checking, by the computing system, listing information of the listing service for updated information pertaining to the first business and/or the second business; and
consequent to identifying updated information pertaining to the first business and/or the second business, including, by the computing system, the updated information in the windowed set of information.

5. The computer-implemented method for personalized orchestration of business information of claim 1, wherein the window information comprises geo-specific criteria, and the windowed set of information comprises geo-specific business information identified based at least in part on the geo-specific criteria.

6. The computer-implemented method for personalized orchestration of business information of claim 1, further comprising:
processing, by the computing system, an indication of end-user interest in the first business; and
correlating, by the computing system, the first business to the first collection of the one or more collections, based at least in part on identifying a relevance of the first business to the first theme of the first collection.

7. The computer-implemented method for personalized orchestration of business information of claim 1, wherein the windowed set of information comprises user-generated content garnered from one or more of: the identified end user; the listing service; and/or a third-party data source.

8. A system to provide personalized orchestration of business information relating to one or more businesses of interest to an identified end user, the system comprising:
one or more network interfaces configured to facilitate access to one or more networks;
one or more processors coupled to the one or more network interfaces;
one or more storage media coupled to the processor to retain instructions, the one or more processors to execute the instructions to:
process first information corresponding to a first business that is associated with an identified end user, the first information being received via a network, and the first business corresponding to a first participant in a listing service;
process second information corresponding to a second business that is associated with the identified end user, the second information being received via the network, and the second business corresponding to a second participant in the listing service;
process curation information associated with the identified end user, the curation information comprising:
collection information at least partially specifying one or more collection characteristics of collections of business information, each collection of the collections of business information being associated with a respective theme, the collections of business information comprising:
a first collection that is associated with a first theme and that includes the first information corresponding to the first business; and
a second collection that is associated with a second theme and that includes the second information corresponding to the second business; and
window information at least partially specifying one or more window characteristics that comprise one or more user-specific customizations as to how content relating to the first collection and/or the second collection is to be provided to the identified end user, wherein the one or more user-specific customizations were indicated by the identified end user via an end-user computing device;
retain the curation information in at least one repository of one or more repositories;
process a request initiated by the identified end user to share business information related to the first collection and/or the second collection with a second user, the request being received via at least one of the one or more networks and specifying one or more of the first collection, the second collection, the first business, and/or the second business;
responsive to the request to share business information:
access the curation information for the identified end user;
access a set of business information related to the first business and/or the second business, wherein the set of business information comprises business listing information and is retained in at least one repository of the one or more repositories; and
window the set of business information related to the first business and/or the second business, wherein the windowing is at least partially a function of the window information, the windowing comprising:
processing the set of business information related to the first business and/or the second business based at least in part on the curation information for the identified end user to at least partially form a windowed set of information; and
transmitting, via at least one of the one or more networks, the windowed set of business information to facilitate display of at least part of the windowed set of business information with a second end-user computing device, the second end-user computing device being associated with the second end user that is different from the identified end user.

9. The system to provide personalized orchestration of business information of claim 8, wherein the one or more processors are to further execution instructions to:
process a second request that corresponds to a request to facilitate information display in accordance with the curation information for the identified end user; and
transmit a second windowed set of business information, wherein the transmitting is directed to the end-user computing device or another end-user computing device associated with the identified end user.

10. The system to provide personalized orchestration of business information of claim 8, wherein the first business and/or the second business were individually selected by the identified user via the end-user computing device.

11. The system to provide personalized orchestration of business information of claim 8, wherein the windowing the set of business information related to the first business and/or the second business further comprises:
checking listing information of the listing service for updated information pertaining to the first business and/or the second business; and
consequent to identifying updated information pertaining to the first business and/or the second business, including the updated information in the windowed set of information.

12. The system to provide personalized orchestration of business information of claim 8, wherein the window information comprises geo-specific criteria, and the windowed set of information comprises geo-specific business information identified based at least in part on the geo-specific criteria.

13. The system to provide personalized orchestration of business information of claim 8, wherein the one or more processors are to further execution instructions to:
process an indication of end-user interest in the first business; and
correlate the first business to the first collection of the one or more collections, based at least in part on identifying a relevance of the first business to the first theme of the first collection.

14. The system to provide personalized orchestration of business information of claim 8, wherein the windowed set of information comprises user-generated content garnered from one or more of: the identified end user; the listing service; and/or a third-party data source.

15. One or more non-transitory, machine-readable media having machine-readable instructions thereon which, when executed by one or more computers or other processing devices, implements a method for personalized orchestration of business information relating to one or more businesses of interest to an identified end user, causing the one or more computers or other processing devices to:
process first information corresponding to a first business that is associated with an identified end user, the first information being received via a network, and the first business corresponding to a first participant in a listing service;
process second information corresponding to a second business that is associated with the identified end user, the second information being received via the network, and the second business corresponding to a second participant in the listing service;
process curation information associated with the identified end user, the curation information comprising:
collection information at least partially specifying one or more collection characteristics of collections of business information, each collection of the collections of business information being associated with a respective theme, the collections of business information comprising:
a first collection that is associated with a first theme and that includes the first information corresponding to the first business; and
a second collection that is associated with a second theme and that includes the second information corresponding to the second business; and
window information at least partially specifying one or more window characteristics that comprise one or more user-specific customizations as to how content relating to the first collection and/or the second collection is to be provided to the identified end user, wherein the one or more user-specific customizations were indicated by the identified end user via an end-user computing device;
retain the curation information in at least one repository of one or more repositories;
process a request initiated by the identified end user to share business information related to the first collection and/or the second collection with a second user, the request being received via a network and specifying one or more of the first collection, the second collection, the first business, and/or the second business;
responsive to the request to share business information:
access the curation information for the identified end user;
access a set of business information related to the first business and/or the second, wherein the set of business information comprises business listing information and is retained in at least one repository of the one or more repositories; and
window the set of business information related to the first business and/or the second business, wherein the windowing is at least partially a function of the window information, the windowing comprising:
processing the set of business information related to the first business and/or the second business based at least in part on the curation information for the identified end user to at least partially form a windowed set of information; and
transmitting, via the network, the windowed set of business information to facilitate display of at least part of the windowed set of business information with a second end-user computing device, the second end-user computing device being associated with the second end user that is different from the identified end user.

16. The one or more non-transitory, machine-readable media of claim 14, wherein the instructions further cause the one or more computers or other processing devices to:
process a second request that corresponds to a request to facilitate information display in accordance with the curation information for the identified end user; and
transmit a second windowed set of business information is directed to the end-user computing device or another end-user computing device associated with the identified end user.

17. The one or more non-transitory, machine-readable media of claim 14, wherein the first business and/or the second business were individually selected by the identified user via the end-user computing device.

18. The one or more non-transitory, machine-readable media of claim 14, wherein the windowing the set of business information related to the first business and/or the second business further comprises:
checking listing information of the listing service for updated information pertaining to the first business and/or the second business; and
consequent to identifying updated information pertaining to the first business and/or the second business, including the updated information in the windowed set of information.

19. The one or more non-transitory, machine-readable media of claim 14, wherein the window information comprises geo-specific criteria, and the windowed set of information comprises geo-specific business information identified based at least in part on the geo-specific criteria.

20. The one or more non-transitory, machine-readable media of claim 14, wherein the instructions further cause the one or more one or more computers or other processing devices to:
process an indication of end-user interest in the first business; and
correlate the first business to a relevant collection of the one or more collections, based at least in part on identifying a relevance of the first business to the first theme of the first collection
